(19) United States
(12) Patent Application Publication
(10) Pub. No.: US 2026/0045378 A1
(43) Pub. Date: Feb. 12, 2026

(54) CONTROL ROD DRIVE MECHANISM WITH DRIVE SHAFT HOLD OUT MECHANISM

(71) Applicant: NuScale Power, LLC, Corvallis, OR (US)

(72) Inventors: Rob Morrow, Corvallis, OR (US); Iljung Jun, Changwon-si (KR)

(73) Assignee: NuScale Power, LLC, Corvallis, OR (US)

(21) Appl. No.: 18/796,951

(22) Filed: Aug. 7, 2024

(51) Int. Cl. G21C 19/115

(52) U.S. Cl. CPC G21C 19/115

(57) ABSTRACT

Techniques for latching a shaft assembly with an integrated system are discussed herein. The integrated system including a nuclear reactor configured to raise a stem of the shaft assembly into a hold out. The hold out can include a sleeve, and metallic balls, the metallic balls being positioned in openings of the sleeve. The hold out can include a housing positioned around the sleeve and the metallic balls. The housing can include a gap that is narrower than a chamber of the housing. The hold out can include a spring coupled to the sleeve. The hold out can include an electromagnetic coil configured to engage the spring and the sleeve to raise the stem until the metallic balls are moved from positions between the gap of the housing and the stem, to positions between the chamber of the housing and the stem.

### STATEMENT REGARDING FEDERALLY SPONSORED RESEARCH

This invention was made with Government support under Contract No. DE-NE0008928 awarded by the Department of Energy. The Government has certain rights in this invention.

### BACKGROUND

Nuclear reactors process fuel to generate heat that may be harnessed to generate steam, which is useful for various industrial processes, including the generation of electricity. When the fuel inside a nuclear reactor core is no longer useful, the used (“or spent”) fuel must be removed and replaced by new fuel. Typically, the spent fuel is removed from the top of the nuclear reactor and the new fuel is lowered into the nuclear reactor core from the top. In order to remove and replace the spent fuel, the containment vessel lid and the reactor vessel head are removed, a crane removes one fuel bundle at a time from the reactor and transfers it to a spent fuel storage rack until about a third of the fuel is removed from the reactor. The process is reversed when new fuel is placed in the reactor. During the removal of the spent fuel, shaft assemblies (e.g., and drive shafts therein) typically are lowered into the bottom of the reactor, to remain in the reactor until refueling is complete.

### BRIEF DESCRIPTION OF THE DRAWINGS

The Detailed Description is set forth concerning the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

FIG. 1 schematically illustrates a Small Modular Reactor (SMR) system with Nuclear Power Modules (NPMs) and control rod drive mechanisms (CRDMs) that have drive shaft hold out mechanisms for holding control rod drive shaft assemblies (CRDSAs) during refueling.

FIG. 2 schematically illustrates an NPM integrated with a CRDM drive shaft hold out mechanism (e.g., rod hold out (RHO)) for holding a CRDSA during refueling.

FIGS. 3A-3C illustrate a side-looking cross-sectional view of an RHO with a de-energized electromagnetic coil and a side-looking cross-sectional view of a CRDSA being inserted into an RHO, at different points in time while a latching system performs an engagement process.

FIG. 4 illustrates a side-looking cross-sectional view of an RHO with a de-energized electromagnetic coil and a side-looking cross-sectional view of the CRDSA of FIG. 3A, a close-up cross-sectional view of a portion of the RHO, and a close-up cross-sectional view of a portion of the CRDSA.

FIGS. 5A-5D illustrate a close-up cross-sectional view of a portion of an RHO and a close-up cross-sectional view of a portion of a CRDSA being inserted into the RHO, at different points in time during an engagement process.

FIGS. 6A-6C illustrate a side-looking cross-sectional view of an RHO with an energized electromagnetic coil and a side-looking cross-sectional view of a CRDSA being extracted from the RHO, at different points in time during a dis-engagement process.

FIG. 7 illustrates a side-looking cross-sectional view of an RHO with a de-energized electromagnetic coil and a side-looking cross-sectional view of a CRDSA, a close-up cross-sectional view of a portion of the RHO, and a close-up cross-sectional view of a portion of the CRDSA.

FIGS. 8A-8D illustrate a side-looking cross-sectional view of an RHO with an energized electromagnetic coil and a side-looking cross-sectional view of a CRDSA, at different points in time during a dis-engagement process.

FIG. 9 illustrates a flowchart describing an example process for controlling a CRDSA.

FIG. 10 is a partially schematic, partially cross-sectional view of a nuclear reactor system configured in accordance with embodiments of the present technology.

FIG. 11 is a partial schematic, partial cross-sectional view of a nuclear reactor system configured in accordance with additional embodiments of the present technology.

FIG. 12 is a schematic view of a nuclear power plant system including multiple nuclear reactors in accordance with embodiments of the present technology.

### DETAILED DESCRIPTION

### Overview

This disclosure is directed to a control rod drive mechanism (CRDM) with a drive shaft hold out mechanism (e.g., rod hold out (RHO) mechanism) (also simply referred to herein, as “RHO device” or “RHO”) included at the top of the CRDM that engages the top portion of a control rod drive shaft assembly (CRDSA) of a nuclear reactor and suspends the CRDSA (e.g., and drive shafts therein) during refueling of the nuclear reactor. The RHO can suspend the CRDSA at a height that is greater than the height of the CRDSA at its normal fully withdrawn range of travel, without the need for electrical power. Typically, spent fuel is removed from a nuclear reactor from the top, and new fuel is inserted from the top, while shaft assemblies (e.g., and drive shafts therein) rest on the bottom of the nuclear reactor. Because a typical nuclear reactor is refueled through the top and includes shaft assemblies that have relatively short lengths or shaft assemblies that are not configured to separate from the control rods, the shaft assemblies (e.g., drive shafts) do not have a potential of being exposed below the top of the nuclear reactor during refueling. During a typical refueling procedure of a typical reactor, the shaft assemblies rest on the bottom of the reactor, while the control rod drive assembly is withdrawn from the top. However, various shapes and sizes of nuclear reactors may render refueling through the top of a nuclear vessel impracticable. For example, an embodiment of a nuclear reactor may include a lower reactor vessel portion (containing spent fuel and the control rods) that is removed to withdraw spent fuel and a new lower reactor vessel portion (containing new fuel) is installed.

In an embodiment, a reactor pressure vessel (RPV) of the nuclear reactor may include the lower reactor vessel portion (e.g., an RPV lower head) that is removed and replaced. For example, the RPV lower head may include a reactor core, where control rods are raised and lowered, via the CRDSA, as necessary for operation. In an embodiment, the CRDSA may include a tube (i.e., a sheath) surrounding a stem. The CRDSA may be configured to couple the CRDM to the control rods during normal operation. The CRDSA may be configured to de-couple from the control rods and engage with the RHO during refueling operations.

According to some examples, because the CRDSA is driven by the CRDM coupled to the top of the RPV, the CRDSA may extend through an RPV upper head of the RPV. For instance, the CRDSA, extending down from the top of the RPV and through an entirety of the RPV upper head, may be coupled at the bottom of the RPV upper head, and/or at the top of the RPV lower head, to the control rods. The sheath and the stem of the CRDSA may extend down from the top of the RPV and through the entirety of the RPV upper head, which may include a steam generator and a pressurizer of the nuclear reactor. The CRDSA coupled to the control rods may be configured to raise and lower the control rods in the RPV lower head. Accordingly, while the RPV lower head may be removed during the refueling process, the CRDSA may be too long to be easily or practicably removed from the reactor.

In these embodiments, and during the refueling of the reactor, the CRDSA may lower the control rods into the bottom of the RPV lower head. The CRDSA may be decoupled from the control rods. The RPV lower head (containing the spent fuel and the control rods) may be removed. The CRDSA may be held by the RHO in the RPV upper head. A new RPV lower head (containing new fuel and control rods) may be installed, and the CRDSA may be coupled to the newly installed control rods.

In an embodiment, the nuclear reactor may include a nuclear power module (NPM) with the RPV that has one or more CRDMs configured to include an RHO. The RHO can be utilized to hold a CRDSA at the top of the RPV. The RHO may hold the CRDSA at the top of the RPV during refueling of the RPV. The CRDSA may be raised by one or more drive coils within the CRDM so that the entire CRDSA may be fully positioned within the RPV. Instead of being removed, the CRDSA may remain in the RPV during refueling. Leaving the CRDSA in the RPV during refueling is simpler than removing the CRDSA due to the relatively large lengths of the sheath and the stem within the CRDSA. The relatively large lengths of the sheath and the stem within the CRDSA make removal of the CRDSA difficult and impracticable. Because the CRDSA is separated from the control rods during refueling, the CRDSA can be left in the RPV while the control large are removed along with the RPV lower head.

During refueling of the RPV, the CRDSA can be inserted (also referred to herein as “raising”) into the RHO and remain suspended within the RHO during an engagement process (also referred to herein as “engagement”). Raising the CRDSA into the RHO can include inserting the CRDSA into an opening (e.g., an aperture) of a housing of the RHO. After the CRDSA is inserted into the RHO, the RHO can utilize balls positioned in a sleeve of the RHO to hold the CRDSA in place. The sleeve may be positioned in the RHO such that the sleeve maintains contact with the housing (e.g., a planar engagement). For example, the balls holding the CRDSA in place may be positioned in a gap of the housing, the gap being narrower in diameter (e.g., a first diameter) than a chamber of the housing having a larger diameter than the gap (e.g., a second diameter), the chamber being above the gap. During insertion of the CRDSA, the CRDSA can be lowered so that a lip of the CRDSA rests on the balls. The sleeve of the RHO, which may be positioned in a housing of the RHO, may include openings disposed radially along a bottom portion of the sleeve that encapsulate the balls. While in the openings, the balls may be able to freely move laterally within the openings. The openings may be radially positioned at a lower portion of the sleeve. The CRDSA may include a channel that enables the balls to slide up and down in the housing, as the CRDSA is inserted in the RHO. The channel may be positioned at an upper portion of the CRDSA. The channel may be defined by lips, such as the lip (e.g., an upper lip of a sheath of the CRDSA) that rests on the balls. The upper lip may be separated from the lower lip by a distance large enough for the metallic balls to be partially disposed within the channel. The sleeve of the RHO may be lowered to rest on a ledge of the housing of the RHO. The sleeve resting on the ledge of the housing of the RHO may hold the balls in place while the CRDSA (e.g., the lip of the CRDSA) rests on the balls.

The engagement process may be used to cause the RHO to hold the CRDSA within the RHO while the nuclear reactor is refueled. Inserting the CRDSA may include raising the CRDSA to position the upper portion of the CRDSA within the sleeve. While the CRDSA is raised, a shoulder of the sheath at the upper portion of the CRDSA can be used to press against the balls in order to raise the balls and the sleeve. After the shoulder of the sheath presses against the balls, the sheath can be raised further until a stem of the CRDSA (e.g., a top portion of the stem) contacts a plunger of the RHO. The CRDSA and the plunger can be raised together, and then lowered together. For example, the CRDSA and the plunger can be lowered together until the sleeve of the RHO contacts the ledge of the housing. Although described throughout this disclosure as being separate pieces, it is understood that the plunger and the sleeve may be one piece.

Engaging the RHO to hold the CRDSA (i.e., the engagement process) can include resting the CRDSA on the balls of the RHO. For example, once fully raised within the RHO, the CRDSA and the sleeve can be lowered together until the sleeve rests on the ledge of the housing. Once the sleeve rests on the ledge of the housing, the CRDSA may still be lowered further until the upper lip of the sheath rests on the balls.

The engagement process does not require applying any power to the RHO. For example, movement of the sleeve, the balls, and the plunger, during insertion of the stem and the CRDSA, does not require applying any power to the RHO. Similarly, holding the CRDSA so that the upper lip of the sheath is resting on the balls does not require applying any power to the RHO.

Engaging the RHO to hold the CRDSA may include, after the CRDSA is raised to a predetermined height at an upper portion of the housing, lowering the CRDSA. Lowering the CRDSA may include lowering the sleeve and the CRDSA, together, until the sleeve rests on the ledge of the housing. Lowering the CRDSA may then include continuing to lower the CRDSA until the upper lip of the sheath rests on the balls in the openings of the sleeve. The balls located in the openings of the sleeve, which has a bottom resting on the ledge of the housing, enable the CRDSA to rest. The CRDSA is enabled to rest and be held in place, due to the upper lip of the sheath resting on the balls.

As discussed above, during the refueling of an NPM consistent with these embodiments, the RPV lower head containing the fuel and the control rods may be removed, thereby exposing the CRDSA. During refueling, the CRDSA can be suspended at a height (e.g., a refueling height) that enables the CRDSA to be recessed within the RPV upper head by using the engagement process. After the CRDSA is engaged with the RHO (i.e., after the engagement process), the CRDSA can be held at the refueling height in order for the lowest portion of the CRDSA to be recessed within the RPV upper head. However, before the CRDSA is held at the refueling height, the CRDSA can first be raised to a height (e.g., an insertion height), with the CRDSA being at a position that is higher than a position of the CRDSA the refueling height. For example, the CRDSA can be raised to the insertion height and then lowered to the refueling height, where the CRDSA may remain until the spent fuel is replaced and the new fuel is installed. Additionally, the CRDSA being held at the refueling height may enable the CRDSA to be suspended by the RHO for the duration of the refueling process without using electricity.

In an example embodiment, once the new fuel has been installed, the CRDSA may be dis-engaged from the RHO so that the CRDSA may be lowered to its normal operating height and be coupled to the newly installed control rods. The dis-engagement process (i.e., dis-engagement) may be performed as part of the refueling process and after the lower portion of the NPM (e.g., the RPV lower head) has been replaced. Dis-engagement of the CRDSA from the RHO may include raising the CRDSA within the RHO, as discussed above in further detail, from the resting height to the insertion height. Dis-engagement of the CRDSA from the RHO may be performed while the RPV upper head is coupled with the RPV lower head and electrical power is available to the RHO. Extracting the CRDSA may enable the CRDSA to be lowered to a height (e.g., with the stem being at an operation height) at which the CRDSA has a normal range of travel for routine operations. During the operations with the stem of the CRDSA being positioned at the operation height, the control rods may be raised and/or lowered, as needed, via the CRDSA.

In an embodiment, dis-engaging the CRDSA from the RHO may include raising the sleeve and the CRDSA together (e.g., raising the CRDSA to apply an upward force on the RHO, to raise the CRDSA and the RHO together). Once the sleeve and the CRDSA are raised to the upper portion of the housing (e.g., with the stem being at the insertion height), coils of the RHO can be magnetically energized to hold a spring of the RHO. The spring of the RHO can be held in a compressed state to hold the sleeve and the plunger in a fixed position, as the CRDSA is lowered. In alternative or additional examples, the coils may be magnetically energized to partially or entirely control the spring of the RHO to raise the sleeve and the plunger (e.g., and/or, at a later time, to control the spring of the RHO to lower the sleeve and the plunger). While CRDSA is lowered, the upper lip of the sheath may contact the balls and force the balls outward to rest against a sidewall of the housing. The balls may rest against the sidewall in the chamber of the housing. The balls having been moved outward may allow the CRDSA to be lowered. The balls no longer prevent the CRDSA from being lowered out of the RHO and into the RPV. Following removal of the CRDSA, power supplied to magnetically energize the coils may cease, enabling the sleeve and the plunger to lower until the sleeve rests on the ledge of the housing for future insertion of a CRDSA.

In an example embodiment, dis-engagement of the CRDSA may include moving the CRDSA upward until the stem contacts a bottom portion of the plunger and raises the plunger with the CRDSA (e.g., and, raising the sleeve and the CRDSA together). The sleeve being coupled to the plunger, which is then pressed into the spring, which is coupled to a top portion of the plunger. The spring may apply a force downward onto the top portion of the plunger. The force applied on the plunger by the spring may increase as the spring is compressed. When the upward force of the CRDSA is greater than the downward biasing force that the spring is imposing on the top of the plunger, the CRDSA may raise the sleeve within the housing. Accordingly, as the CRDSA moves up, the metallic balls travel along the lower portion of the housing (e.g., the gap of the housing), and then a sloped portion of the sidewall (e.g., a transition portion of the sidewall) (also referred to herein simply as “transition”). The metallic balls then move outward within the openings toward the larger diameter section at the upper portion of the housing (e.g., the chamber of the housing) and protrude less and less in the center area of the sleeve as the CRDSA raises the sleeve. After the CRDSA and the sleeve are raised (e.g., after the stem is raised to the insertion height), the spring compresses and continues raising the plunger and the sleeve via an electromagnetic force applied by the coils. The spring then holds the plunger in place via an electromagnetic force (e.g., a same or different force) applied by the coils.

While the plunger, and thus the sleeve, is held in place, with the CRDSA being at the insertion height, the CRDSA is lowered and the upper lip of the CRDSA may force the metallic balls outward such that the metallic balls may rest against the larger diameter of the housing (e.g., in the chamber) and no longer protrude into the center area of the sleeve.

Dis-engagement of the CRDSA from the RHO may include the movement of the CRDSA when the metallic balls no longer protrude into the center area of the sleeve. For example, dis-engagement of the CRDSA from the RHO may include the movement of CRDSA, when the CRDSA is being lowered below the insertion height while the stem remains at the insertion height. Dis-engagement of the CRDSA from the RHO may include de-energizing the coils to enable the sleeve to be lowered. For example, the sleeve may be lowered within the housing as result of the electromagnetic force supplied by the coils ceasing. The sleeve is lowered via the downward biasing force of the spring, after the magnetic force ceases. Once the sleeve rests on the ledge of the housing and the CRDSA is positioned below the aperture of the housing (e.g., once the CRDSA returns to the operation height), the dis-engagement process is complete.

### Illustrative Embodiments

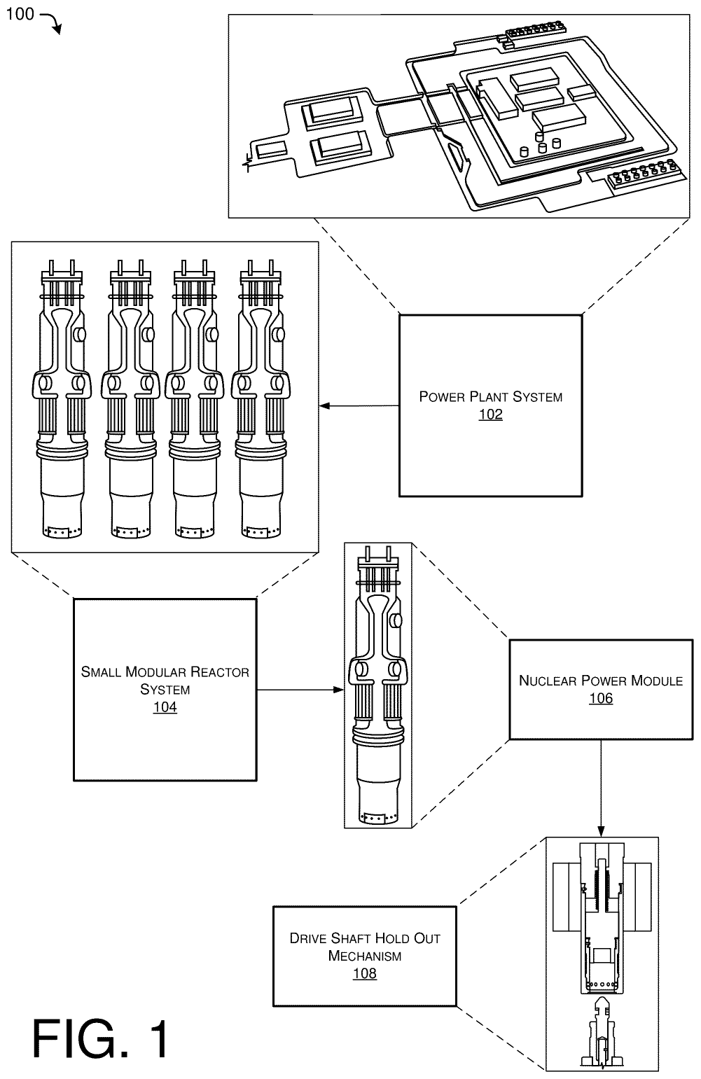

FIG. 1 schematically illustrates a Small Modular Reactor (SMR) system 100 with Nuclear Power Modules (NPMs) 104 and control rod drive mechanisms (CRDMs) that have drive shaft hold out mechanisms 108 for holding control rod drive shaft assemblies (CRDSAs). The SMR system 100 may include a power plant system 102 with NPMs 104. The NPMs 104 may include a nuclear reactor vessel 106 with a drive shaft hold out mechanism (e.g., an RHO, a hold out, etc.) 108. The nuclear power module 106 may be included within the small modular reactor system 104 that is part of the power plant system 102.

In the illustrated embodiment, the SMR system 102 may include a multi-module power plant design with similar NPMs. However, in various instances, the SMR system 102 may represent any type of power plant system including any of various other types of nuclear reactors and/or nuclear reactor systems. For example, the power plant system 102 may include multiple small modular reactors with the same or different sizes, or operating characteristics.

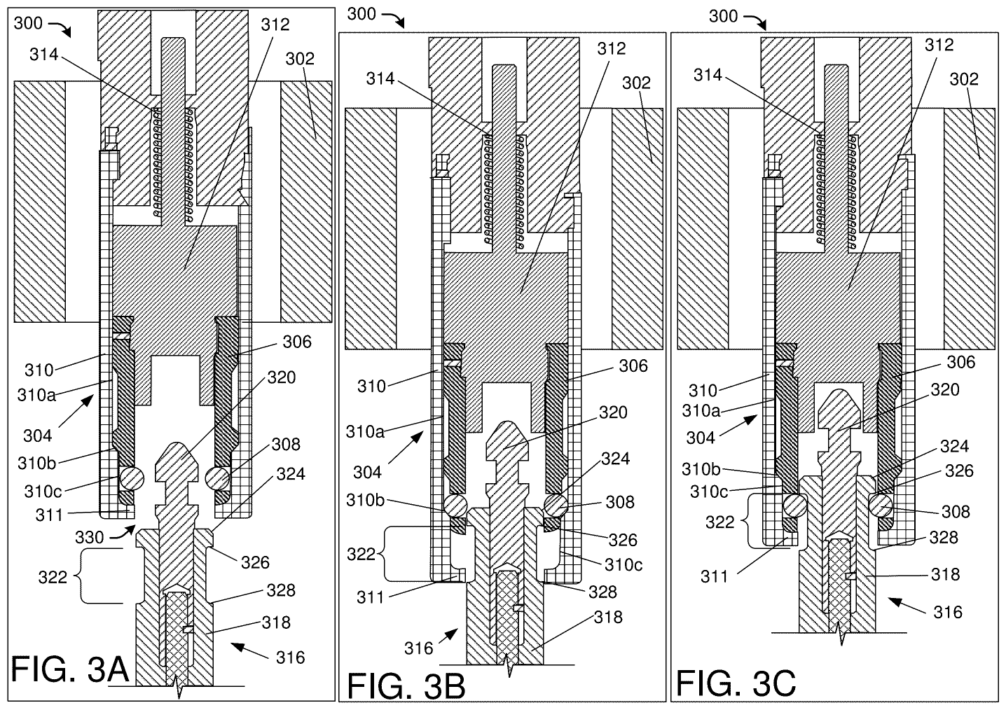

Within the SMR system 102, the RHO 108 may be integrated within the CRDM of the nuclear power module 106. In an embodiment, the RHO 108 may be used to suspend a CRDSA within an RPV at a height above the normal range of operation. In an embodiment, an NPM 104 may include an upper portion that contains the majority of the NPM components (e.g., an integrated steam generator and pressurizer), and the NPM 200 may include a lower portion the contains the nuclear fuel. In these embodiments, refueling the NPM 200 may be performed more quickly by replacing the entire lower portion of the NPM 200 when the fuel is spent and replacing it with a new lower portion containing new fuel. Because the fuel is replaced from the bottom of the NPM 200, removing the CRDSA and the control rods from the top would be impracticable. Additionally, because the control rods are normally disposed near the fuel, the control rods would not be covered when the lower portion of the NPM 200 is removed during the refueling process. By raising the CRDSA into the RHO 108, the RHO 108 may hold the CRDSA at a height (e.g., a refueling height) that may allow the CRDSA to be disposed within the upper portion of the NPM 200 until the CRDSA may be safely lowered into a newly installed lower portion of the NPM 200. For example, holding the CRDSA includes holding a sheath (e.g., the sheath 318, as discussed below with reference to FIG. 3, in further detail), and thereby, a stem (e.g., the stem 320, as discussed below with reference to FIG. 3, in further detail) and drive shafts.

In the illustrated embodiment, the power plant system 102 is configured for use in one or more industrial processes/operations and, more particularly configured to maintain continuous operation while one or more nuclear power modules 106 may be undergoing a refueling process. For example, the small modular reactor system 104 may include multiple nuclear power modules 106, where each nuclear power module 106 includes an RHO 108 for each control rod drive shaft assembly. In an embodiment, one or more of the multiple nuclear power modules 106 may not be operational for a period of time while spent nuclear fuel is being replaced with new fuel. In an embodiment, the RHO 108 allows the nuclear power module to be refueled more quickly as the control rod drive shaft assembly may remain in the nuclear power module 106 during the refueling process, thereby reducing the operational downtime.

In an embodiment, raising the CRDSA (e.g., drive shaft(s)) in an RHO position enables the CRDSA to be held in a position at which the CRDSA is passively held in a fixed (e.g., resting) position by the RHO, without requiring electricity. In a hypothetical example, the CRDSA must be suspended within the RHO 108 for an overhead crane to safely remove the upper portion of the NPM 200 from the lower portion of the NPM 200. For instance, removing the upper portion of the NPM 200 without the CRDSA being suspended with the RHO 108 may be potentially disastrous unless due to an amount (e.g., an amount of the CRDSA that includes some length, such as 45 feet) of the CRDSA being exposed and otherwise unsupported (e.g., if the CRDSA is not raised along with the upper portion). Unless the CRDSA is raised, the portion of the CRDSA may extend into the air above the lower portion of the NPM 200, which may result in the CRDSA tipping over. Removal of the upper portion of the NPM 200 without removal of the CRDSA may result in the inability to rejoin the upper portion of the NPM 200 with the CRDSA, and removal of the upper portion of the NPM 200 without the CRDSA would require an overhead crane to raise the upper portion with enough height to safely avoid the exposed CRDSA. By utilizing the RHO 108 to hold the CRDSA in the upper portion of the NPM 200, the CRDSA (e.g., the drive shaft(s)) can be safely “tucked away” in the upper portion of the NPM 200 during the refueling outages and then quickly reconnected to the control rods after refueling. The RHO 108 allows an overhead crane to remove the upper portion of the NPM 200, including the CRDSA, from the lower portion of the NPM 200 during a refueling process without the use of electricity to hold the CRDSA within the upper portion of the NPM 200.

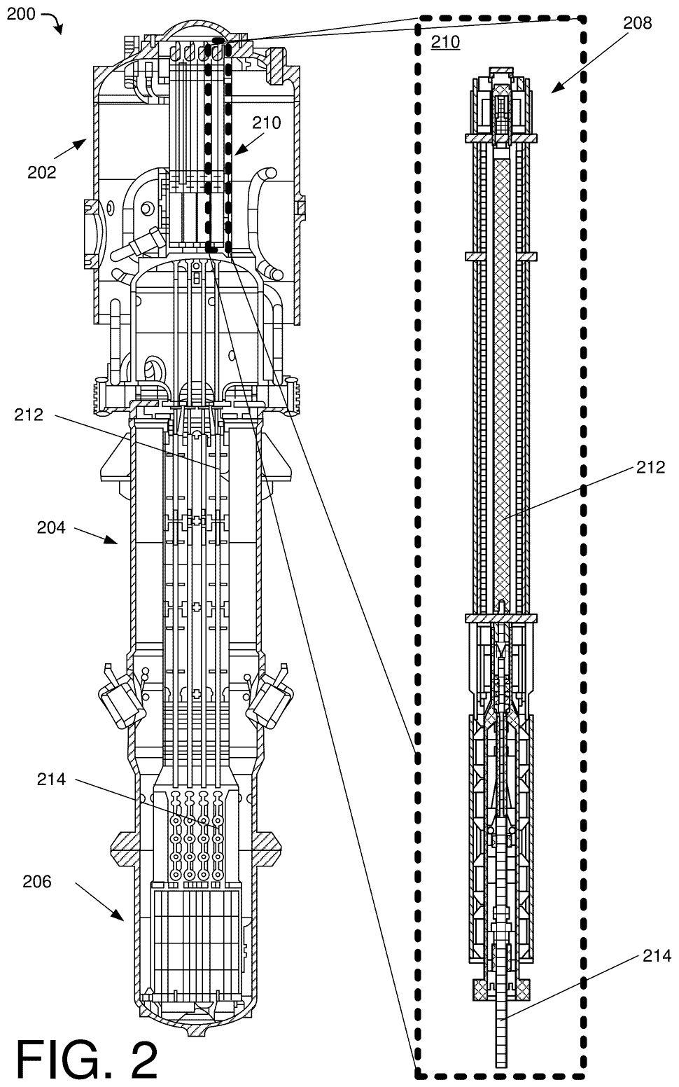

FIG. 2 schematically illustrates an NPM 200 integrated with a CRDM drive shaft hold out mechanism (e.g., rod hold out (RHO)) 208. NPM 200 may include a containment vessel 202, an RPV upper head 204, and an RPV lower head 206. The CRDM 208 that includes an RHO 210 may be disposed within the containment vessel 202 and mounted to the top of the RPV upper head 204. The RPV upper head 204 may include a CRDSA 212. It is understood that the CRDM 208 may include one or more components responsible for causing relative movement of the CRDSA 212 within the NPM 200 (e.g., a motor, one or more magnetic coils, etc.). It is also understood that, in an embodiment, NPM 200 may include multiple CRDMs, RHOs, CRDSAs, and control rods.

In an embodiment, the NPM 200 may include a containment vessel 202, an RPV upper head 204, and an RPV lower head 206 (described in greater detail below regarding FIG. 2). The NPM 200 may be the same or similar to the nuclear power module 106 with respect to FIG. 1. In an embodiment, the NPM 200 may include nuclear fuel and the control rods 214 within the RPV lower head 206. Because the CRDM 208 is installed at the top of the RPV upper head 204, the CRDSA 212 may extend nearly the entire length of the NPM 200 from the top of the RPV upper head 204 to where the CRDSA 212 couples with the control rods 214 that extend into the RPV lower head 206. The CRDSA 212 extending nearly the entire length of the nuclear power module 106 may include a portion of the CRDSA 212 that is inside the top of the RPV upper head 204, and a portion of the CRDSA 212 that is inside of the bottom of the RPV lower head 206 (e.g., during operation of the NPM 200). By way of example, the CRDSA 212 may include drive shafts that each have a portion that is inside the top of the RPV upper head 204, and a portion that is inside of the bottom of the RPV lower head 206 (e.g., during operation of the NPM 200). It is understood that the control rods 214 remain within the RPV lower head 206 when the RPV lower head 206 is separated from the RPV upper head 204.

As a result, the CRSDA 212 may be long enough to extend past the bottom of the RPV upper head 204 when the CRDSA 212 is separated (e.g., uncoupled) from the control rods 214 and the RPV lower head 206 is removed. In these embodiments, when the RPV lower head 206 (containing spent nuclear fuel and the control rods 214) is removed during the refueling process, an RHO (e.g., the RHO 304, as discussed below with reference to FIGS. 3A-3C) may be utilized to prevent the CRDSA 212 from being exposed past the bottom of the RPV upper head 204. The RHO may be utilized to protect the CRDSA 212 from damage after the RPV upper head 204 and the RPV lower head 206 are separated from one another. In these embodiments, the CRDSA 212 may be raised to a height (e.g., an insertion height) that is greater than the maximal operating height that the CRDSA 212 may be disposed within the RPV upper head 204 during normal operations. Once the CRDSA 212 is at the appropriate height (e.g., the insertion height), the RHO 108 can engage with the CRDSA 212 and lower the CRDSA 202 to a different height (e.g., a refueling height). The RHO 108 can suspend the CRDSA 212 in the new position until a replacement RPV lower head 206 with new fuel and new control rods 214 is installed.

FIGS. 3A-3C illustrate a side-looking cross-sectional view of an RHO 304 with a de-energized electromagnetic coil 302 and a side-looking cross-sectional view of the CRDSA 316, at different points in time while a latching system 300 performs an engagement process. Referring to FIG. 3A, the RHO 304 may include an electromagnetic coil 302, a sleeve 306, one or more metallic balls 308, a housing 310, a plunger 312, and a spring 314. In an embodiment, the CRDSA 316 may include a sheath 318, and a stem 320. The sheath 318 may include the channel 322, the shoulder 324, the upper lip 326 and the lower lip 328. In an embodiment, the sleeve 306, the housing 310, the plunger 312, the sheath 318, and the stem 320 may be circular. In an embodiment, the sleeve 306 and the plunger 312 may be configured to move vertically within the housing 310 (i.e., may be raised and lowered). The sleeve 306, the plunger 312, and the sheath 318 may be configured to slide up and down within the housing 310. In an embodiment, the electromagnetic coil 302 may be separate from the RHO 304.

In an embodiment, the engagement process may be a nearly passive process since the RHO 304 does not require electricity during engagement of the CRDSA 316. For example, engagement of the CRDSA 316 only requires electricity for the CRDM drive coils to raise and lower the CRDSA 316. The CRDSA 316 may be inserted (e.g., by the CRDSA 316 being raised via a drive coil) into the RHO 304, through the aperture 330. The CRDSA 316 may be then lowered to be held by the RHO 304. Once the engagement process is completed, the RHO 304 may suspend the CRDSA 316 without using electricity.

The CRDSA 316 can be inserted in the RHO 304 and then lowered to rest in the RHO 304, using the metallic balls 308. For example, the CRDSA 316 can initially be inserted into the RHO 304, using the sheath 318 to raise the metallic balls 308. The CRDSA 316 can be inserted into the RHO 304, using the sheath 318 to move the metallic balls 308 outward. The metallic balls 308 may be moved outward to allow the sheath 318 to be raised past the metallic balls 308. The metallic balls 308 may be moved outward to allow the metallic balls 308 to be lowered, while the sheath 318 remains in place by directing the metallic balls 308 into a channel 322 within the sheath 318. The metallic balls 308 may be moved outward to allow the sheath 318 to be lowered onto the metallic balls 308. It is understood that only raising and/or lowering the CRDSA 316 during the engagement process may require electricity (e.g., for the drive coil used to control movement of the CRDSA 316), but that the RHO 304 does not require the use of electricity to engage the CRDSA 316 and does not require the use of electricity to suspend the CRDSA 316 after the engagement process is complete. It is also understood that once the engagement process has been executed, electricity is not needed to maintain the CRDSA 316 suspended with the CRDSA 316 at a position (e.g., at a refueling height) that is higher than a position of the CRDSA 316 during operation of the NPM 200.

In an embodiment, the housing 310 may include an internal sidewall upon which the metallic balls 308 rest (e.g., laterally rest against the sidewall, in the gap 310c of the housing 310, as discussed below in further detail). In an embodiment the CRDSA 316 may be raised into the RHO through the aperture 330. While being raised through the aperture 330, the sheath 318 may force the plunger 312, and the sleeve 306, to be raised within the housing 310. In in embodiment, the sleeve 306 may be coupled to the plunger 312, and the plunger 312 may be coupled to the spring 314. As the sleeve 306 within the housing 310 is raised by the balls (e.g., being pushed up by the sheath 318), the plunger 312 is also raised, which compresses the spring 314. When the sheath 318 is high enough within the housing 310 (e.g., when the stem 320 is at the insertion height), the spring 314, being able to expand and force the plunger 314 downward, may force the sleeve 306 to be lowered as well. When the sleeve 306 is fully lowered within the housing 310, the CRDSA 316 may be lowered to be suspended in place by the sleeve 306. Specifically, FIG. 3A demonstrates the time during the engagement process where the CRDSA 316 is being inserted into the RHO 304 through the aperture 330.

Referring to FIG. 3B, the CRDSA 316 is raised into the RHO 304 at a height (e.g., the insertion height) that is greater than the normal operating height of the CRDSA 316 as discussed above with reference to FIG. 3A. For example, the RHO 304 is raised to the height that is greater than the normal operating height of the CRDSA 316, at which point the stem 320 is positioned at the insertion height. In contrast to the positions of the CRDSA 316 and the sleeve 306 as depicted in FIG. 3A, the CRDSA 316 and the sleeve 306, as depicted in FIG. 3B are at higher positions relative to the housing 310. In an embodiment, the CRDSA 316 may be raised within the RHO 304 until the shoulder 324 contacts the metallic balls 308. As the CRDSA 316 is raised further, the shoulder 324 presses into the metallic balls 308, which may then slide laterally within openings of the sleeve 306. Alternatively, or additionally, two or more metallic balls 308 may be disposed within a single opening of the sleeve 306. The sleeve 306 moving upward with the CRDSA 316 (e.g., based on a force applied by the CRDSA 316) and pressing into the plunger 312 may then cause the spring 314 to compress.

In an embodiment, as the CRDSA 316 is first raised within the housing, the sleeve 306 may be resting on the ledge 311 of the housing 310 and the metallic balls 308 are disposed within the gap 310c. When CRDSA 316 is raised such that shoulder 324 forces the metallic balls 308 to raise the sleeve 306, the metallic balls 308 may be raised to a transition 310b of the housing 310. Because of the angular shape of the transition 310b, the shoulder 324 may be raised to force the metallic balls 308 outward as the metallic balls 308 continue to be raised and maintain contact with the housing 310. In an embodiment, when the metallic balls reach the chamber 310a of the housing 310, the metallic balls 308 may rest against the housing 310. But, due to the larger diameter of the chamber 310a as compared to the gap 310c, the metallic balls 308 may be repositioned such that the metallic balls 308 do not extend past the sleeve (i.e., the metallic balls 308 may be forced outward such that they are flush with the inside surface of the sleeve). Because the shoulder 324 is no longer contacting the metallic balls 308, the CRDSA 316 may be raised past the metallic balls 308. As depicted in FIG. 3B, the latching process includes the metallic balls 308 having been forced fully outward to the chamber 310a and the CRDSA 316 passing by the metallic balls 308.

Referring to FIG. 3C, the CRDSA 316 may be lowered in the RHO 304 from the height of the CRDSA 316 as discussed above with reference to FIG. 3B. In an embodiment, while the CRDSA 316 is being raised past the metallic balls 308, the metallic balls 308 may be disposed within the sleeve 306. The metallic balls 306 may be positioned between the chamber 310a on one side of the metallic balls 308, and the shoulder 324 on the opposite side of the metallic balls 308. While the metallic balls 308 are positioned between the chamber 310a and the shoulder 324, the sleeve 306 may remain fixed in place within the housing. The angular shape of the transition 310b may prevent the spring 314 from forcing the sleeve 306 downward, so the sleeve 306 remains in place until the CRDSA 316 is raised higher.

In an embodiment, once the CRDSA 316 is raised to a height that positions the upper lip 326 above the top surface of the metallic balls 308, the metallic balls 308 are no longer disposed between the chamber 310a and the shoulder 324. The metallic balls 308 may move from positions between the chamber 310a and the shoulder 324, since the channel 322 provides adequate space for the metallic balls 308 to move. Accordingly, the spring 314, which have been compressed by the sleeve 306, may expand and force the sleeve 306 downward, thereby forcing the metallic balls 308 downward as well. Because the transition 310b of the housing 310 is angularly shaped, the metallic balls 308, maintaining contact with the housing 310, may be directed within the channel. The metallic balls 308 may be directed, by being forced downward into the gap 310c. Once the spring 314 has forced sleeve 306 upon the ledge 311 of the housing 310, the metallic balls 308 may be in a position similar to that as described with respect to FIG. 3A (i.e., the sleeve 306 being against the ledge 311, one side of individual ones of the metallic balls 308 being against the gap 310c of the housing 310, and an opposite side of individual ones of the metallic balls extending past the inside surface of the sleeve). However, because the metallic balls 308 are disposed with the channel 322 between the upper lip 326 and the lower lip 328, the CRDSA 316 may be lowered such that the upper lip 326 may rest on the top surface of the metallic balls 308.

In an embodiment, when the CRDSA 316 is lowered such that the upper lip 326 rests on the top surface of the metallic balls 308, the lower lip 326 may press against the metallic balls 308. The metallic balls 308 may then press against the bottom of the sleeve 306, which is resting upon, and may press against, the ledge of the housing 310. As depicted in FIG. 3C, the latching process includes the CRDSA 316 being suspended at its new height (e.g., a refueling height) after the upper lip 326 rests upon the metallic balls 308, which press on the sleeve that is resting on the ledge 311 of the housing 310.

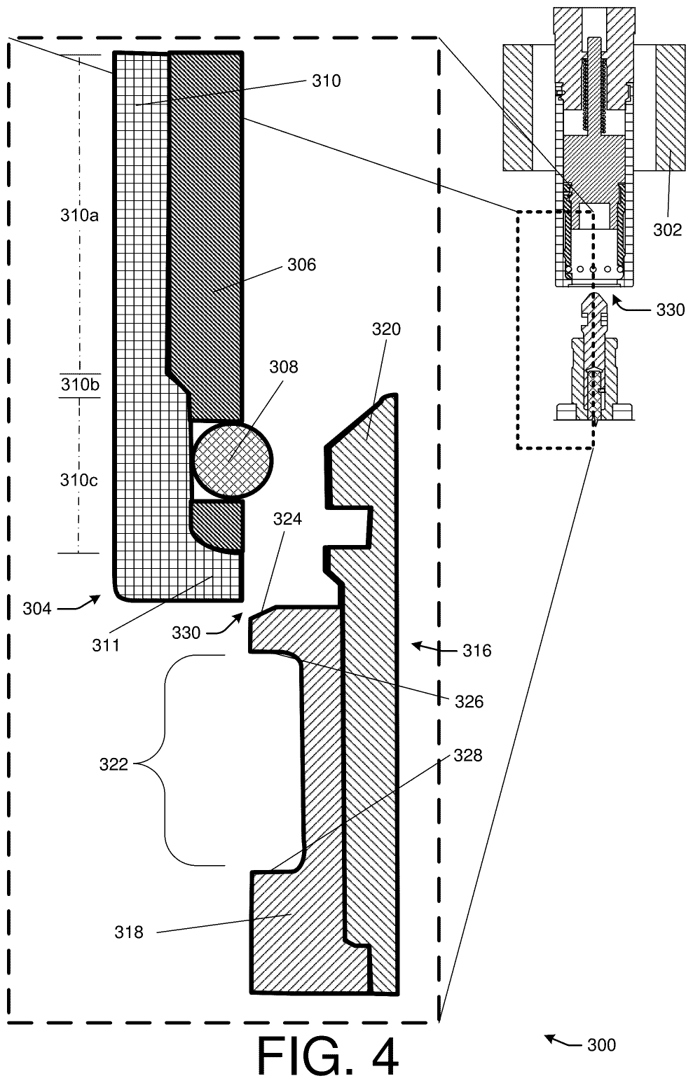

FIG. 4 illustrates a side-looking cross-sectional view of the RHO 304 with a de-energized electromagnetic coil 302 and a side-looking cross-sectional view of the CRDSA 316 of FIG. 3A, a close-up cross-sectional view of a portion of the RHO 304 of FIG. 3A, and a close-up cross-sectional view of a portion of the CRDSA 316 of FIG. 3A, and a close-up cross-sectional view of a portion of the CRDSA 316.

The close-up cross-sectional view of a portion of the RHO 304 of FIG. 3A, and the close-up cross-sectional view of a portion of the CRDSA 316 demonstrate a more detailed and close-up view of the orientation and operation of the RHO 304, the sleeve 306, the metallic balls 308, the housing 310, the chamber 310a, the transition 310b, the gap 310c, the ledge 311, the CRDSA 316, the sheath 318, the stem 320, the channel 322, the shoulder 324, the upper lip 326, and the lower lip 328.

As demonstrated in FIG. 4, the RHO 304 may be positioned above the CRDSA 316, prior to the start of the engagement process. In an embodiment, prior to the start of the engagement process, the sleeve 306 may be resting on the ledge 311 of the housing 310. The metallic balls 308 may be resting laterally against the inside surface of the housing and protruding past an opening within the sleeve. The shoulder 324 of the sheath 318 may have not yet entered the aperture 330 of the housing 310.

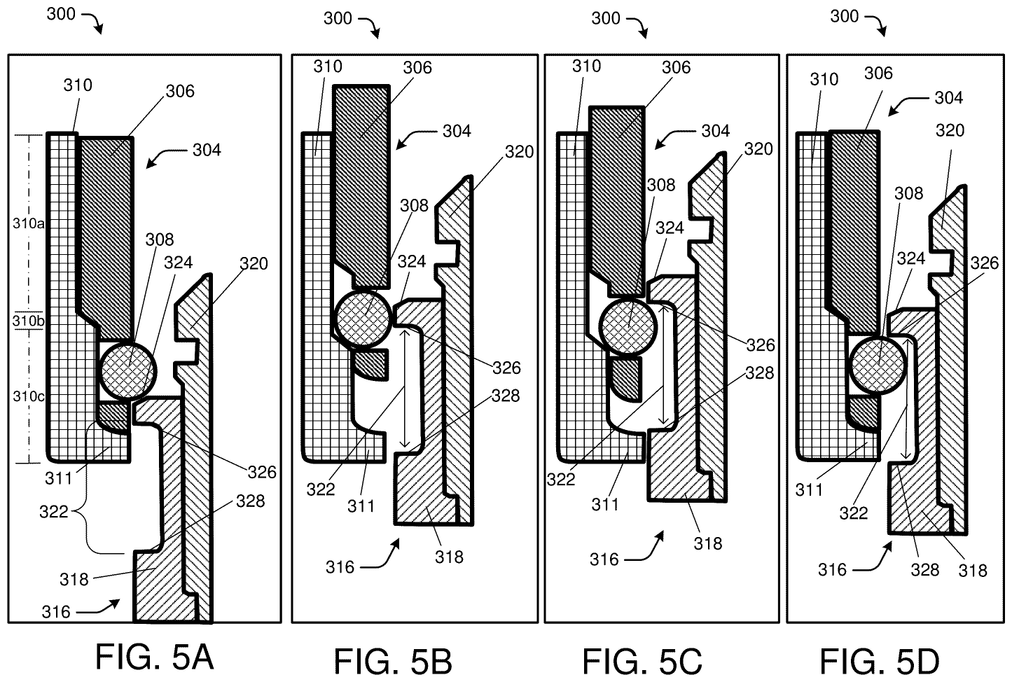

FIGS. 5A-5D illustrate a close-up cross-sectional view of a portion of the RHO 304 and a close-up cross-sectional view of a portion of the CRDSA 316, at different points in time during an engagement process.

Referring to FIG. 5A, the housing 310 may include the chamber 310a, the transition 310b, the gap 310c, and the ledge 311. The sidewall within the housing may include different diameters for the chamber 310a, the transitional 310b, and the gap 310c (i.e., the gap 310c may have a diameter smaller than the diameter of the chamber 310a, while transitional 310b may extend in an angular direction away from the gap 310c and into the chamber 310a). The ledge 311 may be sized to allow the sleeve 306 to rest on a top surface of the ledge 311.

It is understood that the metallic balls 308 may be sized such that when a side surface of the metallic balls 308 is in contact with the sidewall of the gap 310c that the opposite side of the metallic balls 308 extends past the interior surface of the sleeve 306 and the ledge 311. It is also understood that when a side surface of the one or more metallic balls 308 is in contact with the side wall of the chamber 310a, the metallic balls 308 may be sized so that the opposite side surface of the metallic balls 308 does not extend past the interior surface of the sleeve 306 or the ledge 311. The channel 322 within the sheath 318 may be sized such that the channel 322 may partially surround the metallic balls 308 (i.e., the upper lip 326 may be above the top of the metallic balls 308 and the lower lip 328 may also be below the bottom surface of the metallic balls 308.

In an embodiment, the CRDSA 316 may include a sheath 318 and a stem 320. The sheath 318 may include a shoulder 324 and a channel 322. The channel 322 may include an upper lip 326 and a lower lip 328. When the CRDSA 316 is inserted into the RHO 304, the shoulder 324 may contact the metallic balls 308. As the CRDSA 316 continues to be raised within the housing 310, the shoulder 324 may continue to press against the metallic balls 308. The metallic balls 308 may be radially disposed around a bottom portion of the sleeve 306, so as the shoulder 324 presses against the bottom of the metallic balls 308. The metallic balls 308 may be radially disposed such that the metallic balls 308 are pressed into the sleeve 306, which causes the sleeve 306 to be raised. When the shoulder 324 first presses against the metallic balls 308, the sleeve 306 may be in the gap 310c of the housing 310. As depicted in FIG. 5A, the shoulder 324 may first come into contact with the metallic balls 308 during the latching process as the shoulder 324 is raised.

Referring to FIG. 5B, the CRDSA 316, the sleeve 306, and the metallic balls 308 may be raised within the housing 310 such that the metallic balls 308 are in contact with the transition 310b and the chamber 310a of the housing 310. As the shoulder 324 presses against the metallic balls 308 and raises the sleeve 306 (as described above regarding FIG. 5A), the sleeve may be raised within the housing 310 until the metallic balls 308 reach the transition 310b of the housing 310. The angular shape of the transition 310b combined with the upward and outward forces that the shoulder 324 may impose on the metallic balls 308, causing the metallic balls to move laterally within the openings of the sleeve 306. The metallic balls 308 may move laterally, maintaining contact with the sidewall of the transition 310b. As the metallic balls 308 are raised upward and the sleeve progresses to the chamber 310a of the housing 310, the upward and outward forces imposed upon the metallic balls by the shoulder 324 may force the metallic balls 308 fully outward as the metallic balls 308 maintain contact with the sidewall of the chamber 310a of the housing 310.

In an embodiment, when the metallic balls reach the chamber 310a of the housing 310, the metallic balls 308 may rest (e.g., laterally rest) against the housing 310. But, due to the larger diameter of the chamber 310a as compared to the gap 310c, the metallic balls 308 may be positioned to not extend past the sleeve into the aperture 330 (i.e., the metallic balls 308 may be forced outward such that they are flush with the inside surface of the sleeve). Because the shoulder 324 no longer has a bottom surface of the metallic balls 308 to press against, the CRDSA 316 may be raised past the metallic balls 308. FIG. 3B depicts the CRDSA 316 being raised within the RHO 304 such that the shoulder 324 being raised past the metallic balls 308, while the metallic balls 308 remain in contact with the chamber 310a of the housing 310.

Referring to FIG. 5C, the CRDSA 316 may be raised into the RHO 304 at a height that is greater than a height of CRDSA 316 as discussed above with reference to FIG. 5B. In an embodiment, while the CRDSA 316 is being raised past the metallic balls 308, the metallic balls 308 may be disposed within the sleeve 306 with the chamber 310a on one side of the metallic balls 308 and the shoulder 324 on the opposite side of the metallic balls 308. While the metallic balls 308 are positioned between the chamber 310a and the shoulder 324, the sleeve 306 may be unable to be raised within the housing. The angular shape of the transition 310b may prevent the sleeve 306 from moving downward (as depicted in FIG. 5B), so the sleeve 306 remains in place until the CRDSA 316 is raised higher.

In an embodiment, once the CRDSA 316 is raised to a height that positions the upper lip 326 above the top surface of the metallic balls 308, the metallic balls 308 may be no longer disposed between the chamber 310a and the shoulder 324. The metallic balls 308 may be no longer disposed between the chamber 310a and the shoulder 324, since the channel 322 provides adequate space for the metallic balls 308 to move. Accordingly, the sleeve 306 may be forced downward, which may force the metallic balls 308 downward as well. Because the transition 310b of the housing 310 is angularly shaped, the metallic balls 308 may maintain contact with the housing and be directed with the channel while being forced downward into the gap 310c. As depicted in FIG. 5C depicts, the sleeve 306 may be lowered within the housing 310 and the metallic balls 308 may be directed within the channel 322 of the sheath 318.

Referring to FIG. 5D, the CRDSA 316 and the sleeve 306 may be lowered into the RHO 304 at a height that is lower than a height of CRDSA 316 as discussed above with reference to FIG. 5C. Once the sleeve 306 is lowered down upon the ledge 311 of the housing 310, the metallic balls 308 may be in a position similar to that as described with respect to FIG. 3A (i.e., the sleeve 306 is against the ledge 311, the metallic balls 308 are against the gap 310c of the housing 310, and part of the metallic balls extend past the inside surface of the sleeve). However, because the metallic balls 308 are disposed with the channel 322 between the upper lip 326 and the lower lip 328, the CRDSA 316 may be lowered such that the upper lip 326 may rest on the top surface of the metallic balls 308.

In an embodiment, when the CRDSA 316 may be lowered such that the upper lip 326 rests on the top surface of the metallic balls 308. The lower lip 326 may press against the metallic balls 308. The metallic balls 308 may then press against the bottom of the sleeve 306. The sleeve 306 may press against, and rest on, the ledge 311 of the housing 310. As depicted in FIG. 5D, the latching process includes the CRDSA 316 being suspended at its new height (e.g., the refueling height) after the upper lip 326 rests upon the metallic balls 308, which presses on the sleeve, which is resting on the ledge 311 of the housing 310. In an embodiment, the CRDSA 316 may be suspended at its new height after the upper lip 326 rests upon the metallic balls 308 without the use of electricity.

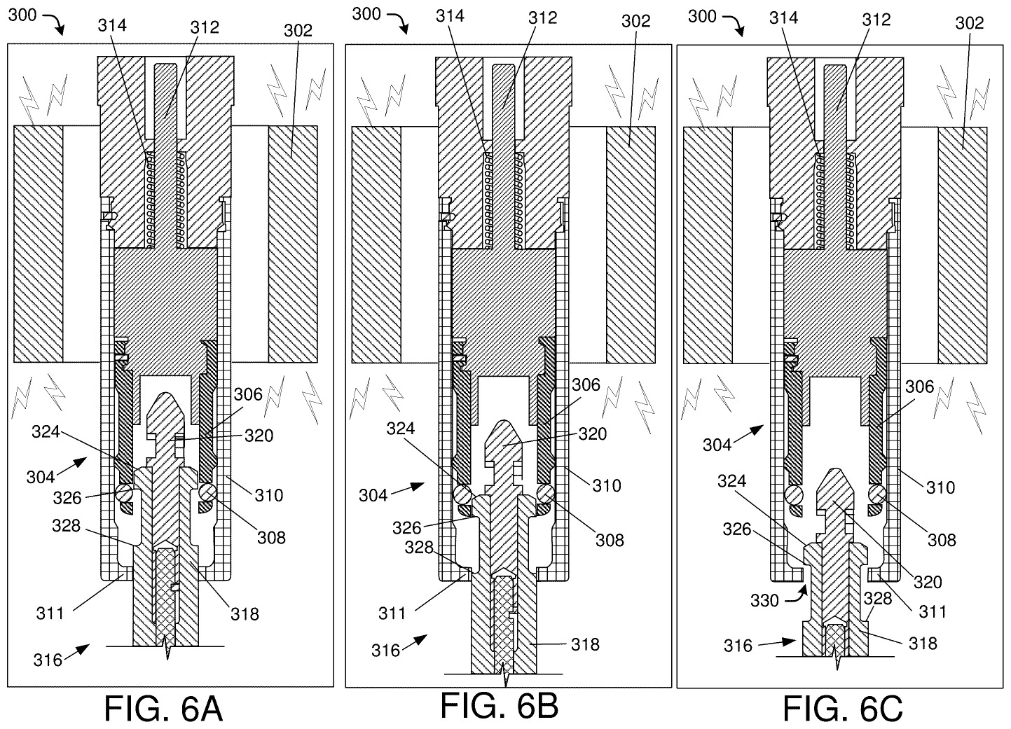

FIGS. 6A-6C illustrate a side-looking cross-sectional view of the RHO 304 with an energized electromagnetic coil 302 and a side-looking cross-sectional view of the CRDSA 316, at different points in time during a dis-engagement process. In an embodiment, the process demonstrated by FIGS. 6A-6D may be performed when the sleeve 306 is against the ledge 311, the metallic balls 308 are against the gap 310c of the housing 310, and part of the metallic balls extend past the Inside surface of the sleeve. Additionally, the metallic balls 308 may be disposed with the channel 322 between the upper lip 326 and the lower lip 328, and the CRDSA 316 may be lowered such that the upper lip 326 rests on the top surface of the metallic balls 308.

In an embodiment, the dis-engagement process may be an active process (e.g., at least a partially active process) (i.e., using electricity, for at least part of the process, for example, to energize the electromagnetic coils) and may include energizing the electromagnetic coil 302 to compress the spring 314 and raise the plunger 312. The raising of the plunger 312 may include raising the sleeve 306. The raising of the sleeve 306 may also raise the metallic balls 308, and the CRDSA 316 resting on the metallic balls 308 via the upper lip 326. During the dis-engagement process, when the metallic balls 308 are raised into the chamber 310a of the housing 310, the metallic balls 308 may be forced outward to allow the upper lip 326 to be lowered below the metallic balls, thus allowing the CRDSA 316 to be removed from within the RHO 304 through the aperture 330.

Referring to FIG. 6A, the electromagnetic coil 302 is energized. In an embodiment, when the electromagnetic coil 302 is energized, the electromagnetic force may be felt by the spring 314, compelling the plunger 312 to raise within the housing 310. It is understood that, in some instances, the electromagnetic force generated by the electromagnetic coil being energized may be sufficient to raise the sleeve 306 from a resting position against the ledge 311 within the gap 310c of the housing 310 to the chamber 310a. Because the electromagnetic force compelling the spring 314 to compress, to raise the plunger 312, may be greater than the downward force the spring 314 imposes on the plunger 312, the plunger may be raised within the housing 310 and the spring 312 may be compressed. Since the plunger 312 is coupled to the sleeve 306, as the plunger 312 raises, the sleeve 306 may be also raised within the housing 310.

In some instances, for example with the sleeve 306 being raised from the resting position by the spring 314, the CRDSA 316 may be also raised, partially or entirely independently from the force applied by the spring 314. For instance, the CRDSA 316 may be raise, partially or entirely independently from the force by the spring 314, as the sleeve 306 is raised. For example, the CRDSA 316, resting on the top surface of the metallic balls 308 (i.e., the upper lip 326 resting upon the top surface of the metallic balls 308 that extend past the sleeve 306), may be raised as the sleeve 306 is raised.

Alternatively, or additionally, the electromagnetic coil 302 may be energized after the plunger 312 is raised (e.g., at least partially to an intermediate height) by the CRDSA 316. Prior to the electromagnetic coil 302 being energized, the plunger 312 may be raised (e.g., to the intermediate height) by the stem 320 pushing against the plunger 312. The electromagnetic force felt on the spring 314 may compel the plunger 312 to raise to a height (e.g., a final height) within the housing 310. Because the electromagnetic force compelling the spring 314 to raise the plunger 312 may be greater than the downward force the spring 314 imposes on the plunger 312, the plunger 312 may be raised within the housing 310 once the plunger 312 reaches the intermediate height.

In an embodiment, as the sleeve 306 is raised within the housing 310, the upper lip 326 may impose a downward force on the metallic balls 308. Because of the position of the upper lip 326 as it rests upon the metallic balls 308, the upper lip 326 may also impose an outward force on the metallic balls 308 that forces the metallic balls 308 into the sidewall of the gap 310c. However, the electromagnetic force compelling the sleeve to raise may be sufficient to cause the sleeve 306 to raise while the upper lip 326 forces the metallic balls to maintain contact with the sidewall of the gap 310c.

In an embodiment, when sleeve 306 is raised such that the metallic balls 308 reach the transition 310b of the housing 310, the angular shape of the transition 310b combined with the downward and outward forces that the upper lip 326 imposes on the metallic balls 308 may cause the metallic balls 308 to move laterally within the openings of the sleeve 306. The metallic balls 308 may maintain contact with the sidewall of the transition 310b. As the metallic balls 308 are raised upward and the sleeve progresses to the chamber 310a of the housing 310, the downward and outward forces imposed upon the metallic balls by the upper lip 326 may force the metallic balls 308 fully outward. The metallic balls 308 may be forced fully outward as the metallic balls 308 maintain contact with the sidewall of the chamber 310a of the housing 310. In an embodiment, when the metallic balls reach the chamber 310a of the housing 310, the metallic balls 308 may rest against the housing 310. But, due to the larger diameter of the chamber 310a as compared to the gap 310c, the metallic balls 308 may not extend past the sleeve (i.e., the metallic balls 308 may have been forced outward such that they are flush with the inside surface of the sleeve). Because the upper lip 326 may no longer have a top surface of the metallic balls 308 to rest upon (e.g., due to the metallic balls 308 being forced outward), the CRDSA 316 may be lowered past the metallic balls. FIG. 6A depicts the moment of the latching process where the metallic balls 308 have been forced fully outward to the chamber 310a and the upper lip 326 may pass by the metallic balls 308.

Referring to FIG. 6B, the CRDSA 316 may be lowered within the RHO 304 at a height that is less than the height of CRDSA 316 as discussed above with reference to FIG. 6A. However, because the electromagnetic coil 302 remains energized, the plunger 312 and the sleeve 306 may still be fully raised within the housing 310. The spring 314 may still be fully compressed. As demonstrated in FIG. 6B, while the electromagnetic coil 302 is energized, and while the plunger 312 and the sleeve 306 are still fully raised within the housing 310, the sheath 318 may be lowered without the upper lip 326 contacting the metallic balls 308.

Referring to FIG. 6C, the CRDSA 316 may be lowered within the RHO 304 at a height that is less than the height of CRDSA 316 as discussed above with reference to FIG. 6B. However, because the electromagnetic coil 302 remains energized, the plunger 312 and the sleeve 306 may still be fully raised within the housing 310. The spring 314 may still be fully compressed. As demonstrated in FIG. 6C, while the electromagnetic coil 302 is energized, and while the plunger 312 and the sleeve 306 are still fully raised within the housing 310, the sheath 318 may be lowered. The sheath 318 being lowered may include the upper lip 326 and the shoulder 324 being lowered to exit the sleeve 306 without restriction. It is understood that the lowering of the CRDSA 316 may not contribute to the return of the sleeve 306, the plunger 312, the spring 314, and the metallic balls 308 to their resting positions (i.e., the sleeve 306 being against the ledge 311, the metallic balls 308 being against the gap 310c of the housing 310, and part of the metallic balls extending past the inside surface of the sleeve).

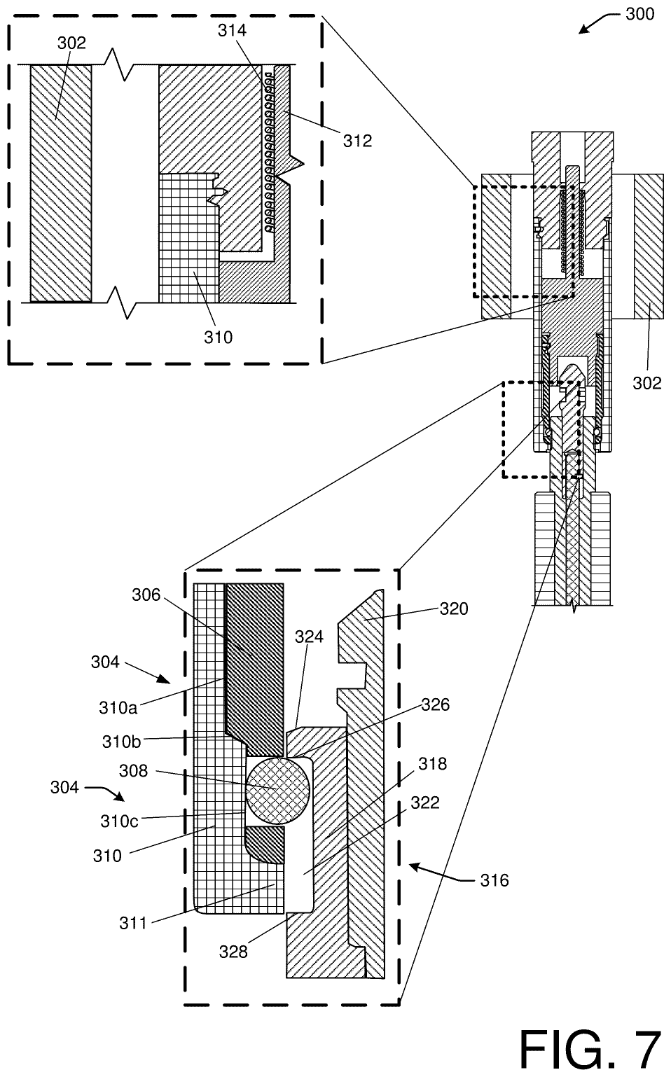

FIG. 7 illustrates a side-looking cross-sectional view of the RHO 304 with a de-energized electromagnetic coil 302 and a side-looking cross-sectional view of the CRDSA 316 of FIG. 3A, a close-up cross-sectional view of a portion of the RHO 304 of FIG. 3A, and a close-up cross-sectional view of a portion of the CRDSA 316 of FIG. 3A.

As illustrated in a more detailed and close-up view in FIG. 7 of the orientation and operation of the electromagnetic coil 302, the RHO 304, the sleeve 306, the metallic balls 308, the housing 310, the chamber 310a, the transition 310b, the gap 310c, the ledge 311, the plunger 312, the spring 314, the CRDSA 316, the sheath 318, the stem 320, the channel 322, the shoulder 324, the upper lip 326, and the lower lip 328, the starting position and condition of each component before the dis-engagement process begins may include the upper lip 326 resting on the metallic balls 308. In an embodiment, before the dis-engagement process begins, the electromagnetic coil 302 may be de-energized, the sleeve 306 may be at its lowest position resting on the ledge 311 of the housing 310, the metallic balls 308 may be in the gap 310c of the housing 310, and the upper lip 326 of the sheath 318 may be resting on a top surface of the metallic balls 308.

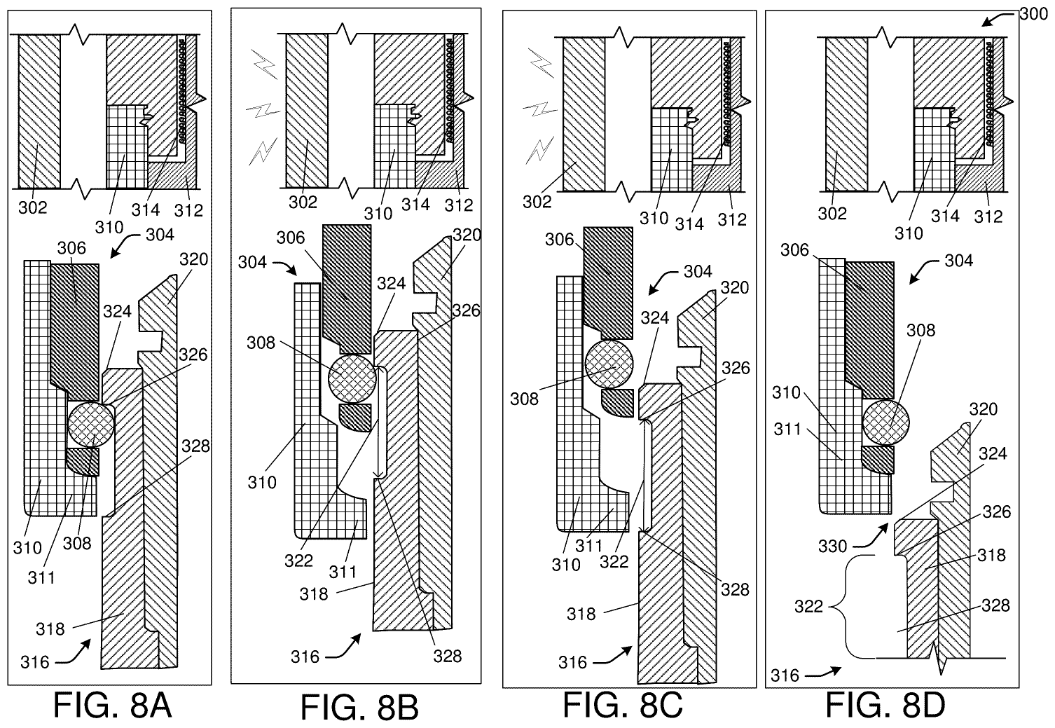

FIGS. 8A-8D illustrate a side-looking cross-sectional view of the RHO 304 with an energized electromagnetic coil 302 and a side-looking cross-sectional view of a CRDSA 316, at different points in time during a dis-engagement process.

As illustrated in FIG. 8A, the latching system 300 in the starting position of each component before the dis-engagement process begins may include the upper lip 326 resting on the metallic balls 308, as described above with respect to FIG. 7 (i.e., the sleeve 306 may be against the ledge 311, the metallic balls 308 may be against the gap 310c of the housing 310, part of the metallic balls may extend past the inside surface of the sleeve into the aperture 330, the metallic balls 308 may be disposed with the channel 322 between the upper lip 326 and the lower lip 328, and the CRDSA 316 may include the upper lip 326 resting on the top surface of the metallic balls 308).

In an embodiment, the CRDSA 316 and the sleeve 306 may be raised. For example, the CRDSA 316, with the sheath 318, may be raised first, so that the upper lip 326 no longer rests on the metallic balls 308. As the sheath 318 is raised (e.g., resulting in the stem 320 being raised until the stem 320 presses into the plunger 312, the sleeve 306 may be raised. Alternatively, or additionally, the electromagnetic force compelling the spring 314 to compress may be utilized to raise the sleeve 306 (e.g., based on the shoulder 324 pressing up on the magnetic balls 308 as the sleeve 306 is raised). For instance, the electromagnetic force compelling the spring 314 to compress may be sufficient to cause the sleeve 306 to raise as the sheath 318 is raised. In such an instance or another instance, the sleeve 306 may be caused to raise partially or entirely independently of the sheath 318 being caused to raise.

The force compelling the spring 314 to be capable of causing the sleeve 306 to remain in place, or another force compelling the spring 314 to be capable of causing the sleeve 306 to be raised, may be generated based on a corresponding size of the coil 302 having capabilities, therefore. For example, the coil 302 being relatively larger may be utilized to raise the sleeve 306, and/or to hold the sleeve 306 in place. Alternatively, the coil 302 being relatively smaller may be utilized to hold the sleeve 306 in place (e.g., but possibly not to raise the sleeve).

FIG. 8B illustrates a side-looking cross-sectional view of the RHO 304 with an energized electromagnetic coil 302 and a side-looking cross-sectional view of the shaft assembly 316 of FIG. 8A.

In an embodiment, after the sleeve 306 is raised within the housing 310 (e.g., and after the electromagnetic force of the spring 314 is utilized to hold the sleeve 306 in place), the CRDSA 316, with the sheath 318, may be lowered by one or more drive coils within the CRDM. The sleeve 306 may be held in place, at a position at which the metallic balls 308 are within the chamber 310a. The CRDSA 316, with the sheath 318, may be lowered until the metallic balls 308 are moved outward and in contact with the chamber 310a of the housing 310. As the sheath 318 is lowered, the upper lip 326 may impose an outward force on the metallic balls 308. For instance, because of the position of the upper lip 326 as the sheath 318 moves down, and as the upper lip 326 moves down and physically contacts the metallic balls 308, the upper lip 326 may impose the outward force on the metallic balls 308 to move the metallic balls 308 into the sidewall of the chamber 310a. As depicted in FIG. 8C, during the latching process, and as the CRDSA 316, with the sheath 318 and the upper lip 326 are lowered, the metallic balls 308 may be forced fully outward to the chamber 310a.

Referring to FIG. 8C, when the metallic balls 308 rest against the chamber 310a of the housing 310 (i.e., after the metallic balls 308 have been forced outward), and because the upper lip 326 has passed the metallic balls 308, the CRDSA 316 may continue to be lowered. As depicted in FIG. 8C, during the dis-engagement process, and after the metallic balls 308 have been forced fully outward to the chamber 310a, the CRDSA 316, with the sheath 318 and the upper lip 326, may continue to be lowered in the housing 310.

The CRDSA 316 may be lowered within the RHO 304 at a height that is less than the height of CRDSA 316 as discussed above with reference to FIG. 8B. However, because the electromagnetic coil 302 remains energized, the plunger 312 and the sleeve 306 may be still fully raised within the housing 310. Because the electromagnetic coil 302 remains energized, the metallic balls 308 may still be contacting the chamber 310a within the housing 310. As demonstrated in FIG. 6C, while the electromagnetic coil 302 is energized and the plunger 312 and the sleeve 306 are still fully raised within the housing 310, the sheath 318 may be lowered after the upper lip 326 contacts, and moves past, the metallic balls 308.

Referring to FIG. 8D, the electromagnetic coil 302 may be de-energized, and the CRDSA 316 may be lowered within the RHO 304. The CRDSA 316 may be lowered within the RHO 304 until the sheath 318 has been fully withdrawn through the aperture 330. Additionally, because the electromagnetic coil 302 is de-energized, the sleeve 306 and the metallic balls 308 may be fully lowered within the housing 310. The CRDSA 316 may be lowered to exit the housing 310; and then the sleeve 306 may lowered to rest on the ledge 311. Alternatively, the CRDSA 316 may be lowered while the sleeve 306 is being lowered.

Dis-engagement of the CRDSA 316 from the RHO 304 may be performed while an RPV upper head (e.g., the RPV upper head 204, as discussed above with reference to FIG. 2) is coupled with an RPV lower head (e.g., the RPV lower head 206, as discussed above with reference to FIG. 2) and electrical power is available to the RHO 304. Extracting the CRDSA 316 may enable the CRDSA 316 to be lowered to a height (e.g., an operation height) at which the CRDSA 316 has a normal range of travel for routine operations. During the operations with the CRDSA 316 being positioned at the operation height, the control rods may be raised and/or lowered, as needed, via the CRDSA 316.

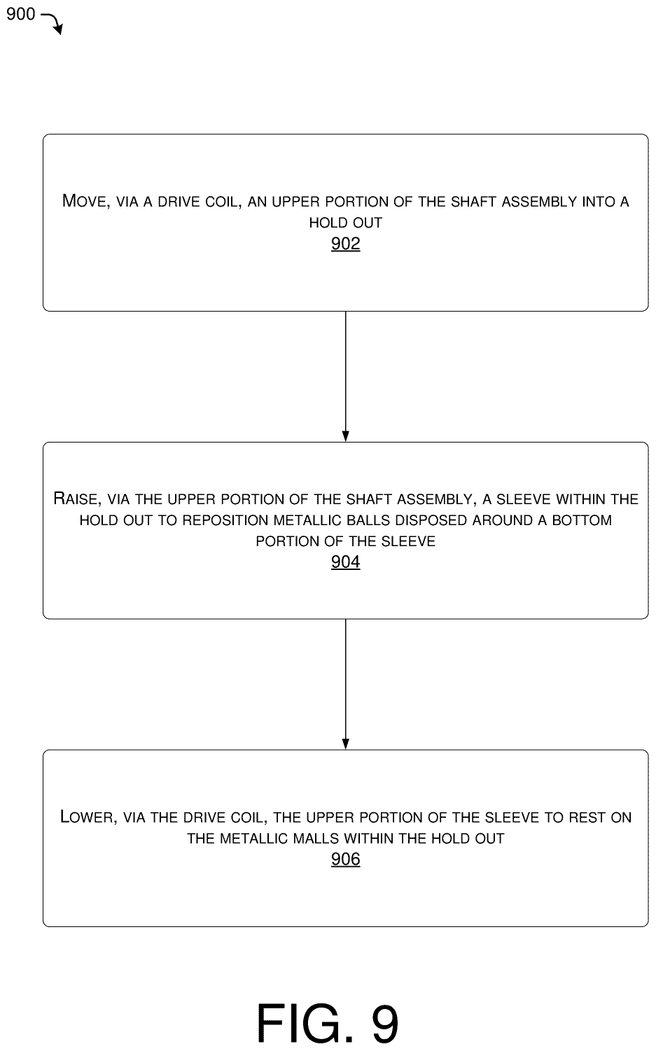

FIG. 9 illustrates a flowchart describing an example process 900 for controlling a CRDSA 316. The order in which the operations or steps are described is not intended to be construed as a limitation, and any number of the described operations may be combined in any order and/or in parallel to implement the latching system 300 (e.g., the latching system 300, as discussed above with reference to FIGS. 3A-8D).

At step 902, the process 900 may include moving, via a drive coil, an upper portion of the shaft assembly into a hold out. For example, a drive coil may raise the CRDSA 316 into the RHO 304 such that the stem 320 and the should 324 go through the aperture 330 of the housing 310.

At step 904, the process 900 may include raising, via the upper portion of the shaft assembly, a sleeve within the hold out to reposition metallic balls disposed around a bottom portion of the sleeve. For example, the sheath 318 of the CRDSA 316 may be raised into the RHO through the aperture 330. While being raised through the aperture 330, the shoulder 324 of the sheath 318 may press upwards against the metallic balls 308 of the sleeve 306 causing the sleeve 306 to be raised within the housing 310. In the example, the sleeve 306 and the metallic balls 308 may be raised to a portion of the housing 310 that allows the shoulder 324 to displace the metallic balls 308 laterally to maintain contact with the upper portion of the housing 310 (e.g., the chamber 310a). Once the metallic balls 308 are laterally resting against the upper portion of the housing, they are no longer being forced upward by the shoulder 324. A spring 314 is then able to force the sleeve 306 and the metallic balls 308 downward such that the metallic balls 308 are positioned between the lower portion of the housing 310 (e.g., the gap 310c) and the channel 322 of the sheath 318.

At step 906, the process 900 may include lowering, via the drive coil, the upper portion of the sleeve 306 to rest on the metallic balls 308 within the hold out. For example, once the metallic balls 308 are positioned between the lower portion of the housing 310 (e.g., the gap 310c) and the channel 322 of the sheath 318, the CRDSA 316 may be lowered until the upper lip 326 pf the channel 322 is resting on the top surface of the metallic balls 308.

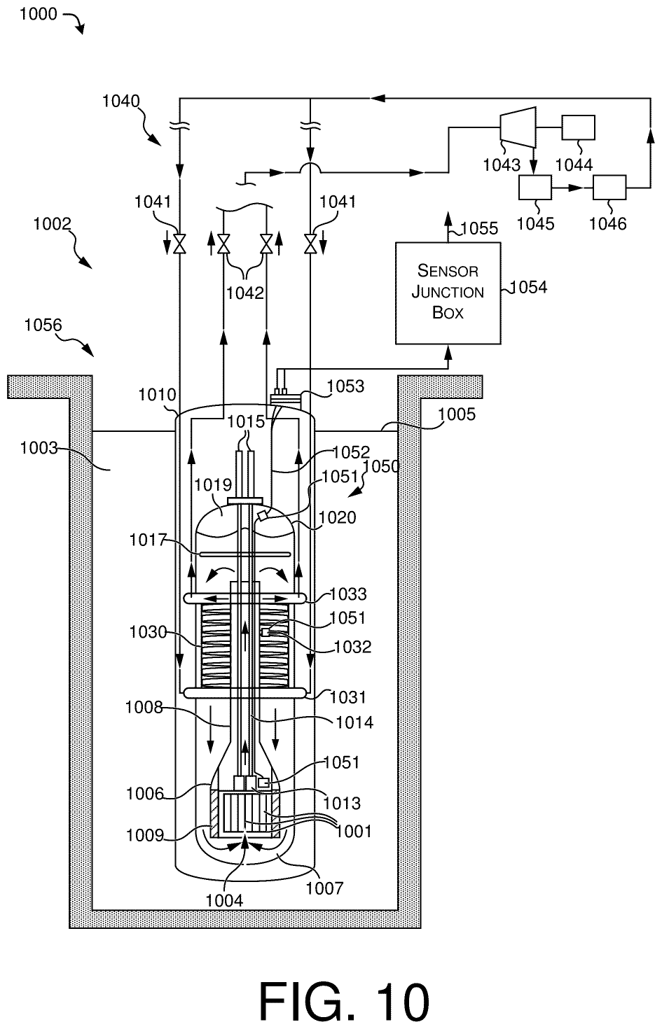

FIG. 10 is a partially schematic, partially cross-sectional view of a nuclear reactor system configured in accordance with embodiments of the present technology.

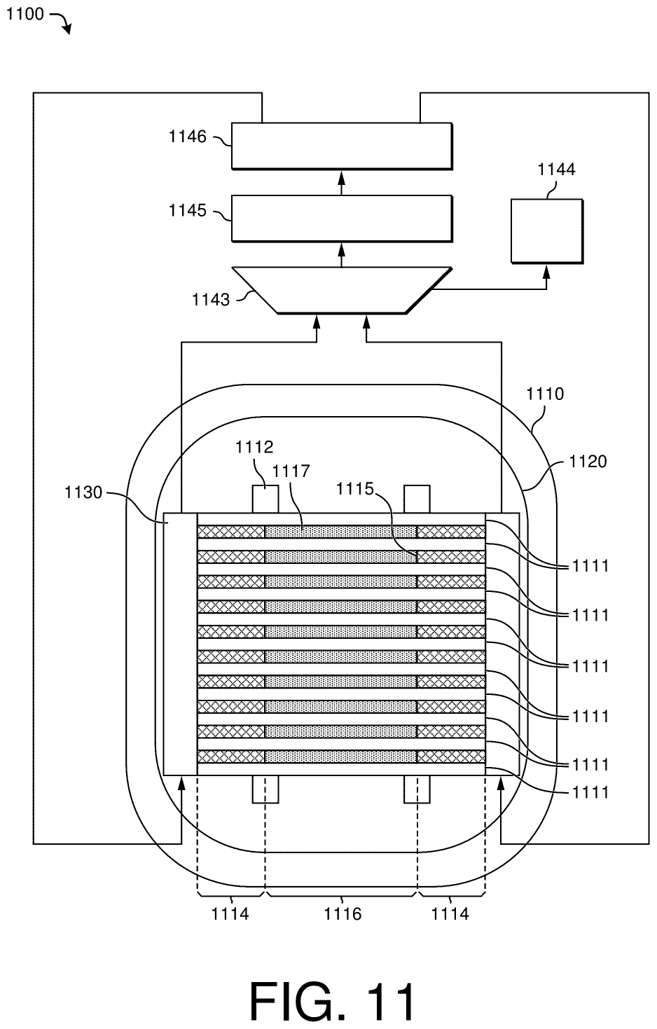

FIG. 11 is a partial schematic, partial cross-sectional view of a nuclear reactor system configured in accordance with additional embodiments of the present technology.

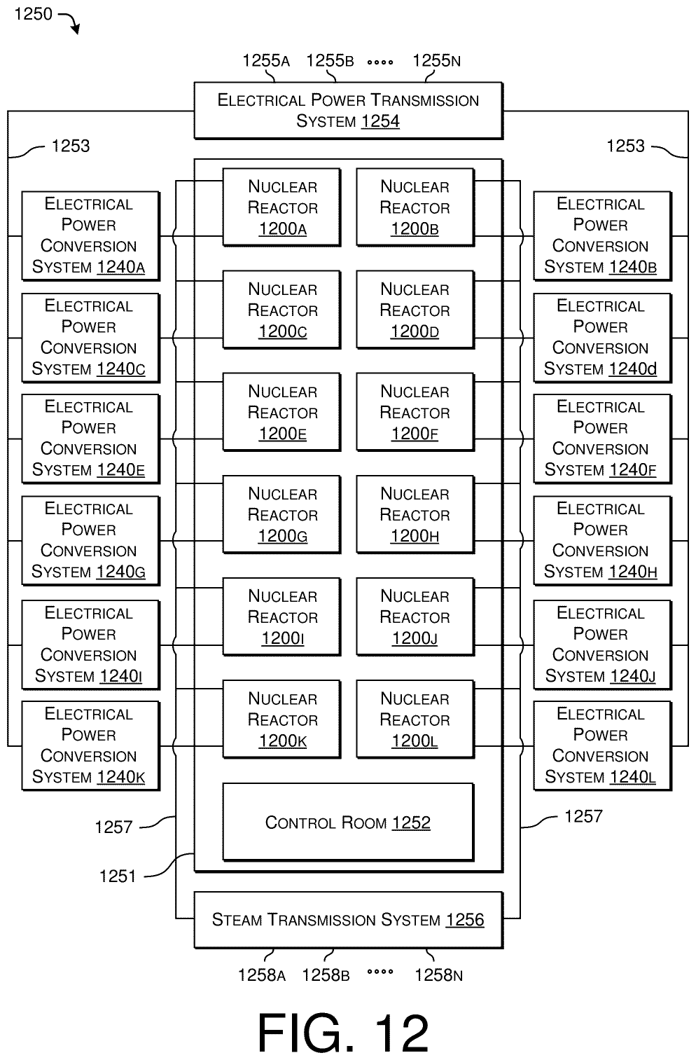

FIG. 12 is a schematic view of a nuclear power plant system including multiple nuclear reactors in accordance with embodiments of the present technology.

FIGS. 10 and 11 illustrate representative nuclear reactors that may be included in embodiments of the present technology. FIG. 10 is a partially schematic, partially cross-sectional view of a nuclear reactor system 1000 configured in accordance with embodiments of the present technology. The system 1000 can include a power module 1002 having a reactor core 1004 in which a controlled nuclear reaction takes place. Accordingly, the reactor core 1004 can include one or more fuel assemblies 1001. The fuel assemblies 1001 can include fissile and/or other suitable materials. Heat from the reaction generates steam at a steam generator 1030, which directs the steam to a power conversion system 1040. The power conversion system 1040 generates electrical power, and/or provides other useful outputs, such as super-heated steam. A sensor system 1050 is used to monitor the operation of the power module 1002 and/or other system components. The data obtained from the sensor system 1050 can be used in real time to control the power module 1002, and/or can be used to update the design of the power module 1002 and/or other system components.

The power module 1002 includes a containment vessel 1010 (e.g., a radiation shield vessel, or a radiation shield container) that houses/encloses a reactor vessel 1020 (e.g., a reactor pressure vessel, or a reactor pressure container), which in turn houses the reactor core 1004. The containment vessel 1010 can be housed in a power module bay 1056. The power module bay 1056 can contain a cooling pool 1003 filled with water and/or another suitable cooling liquid. The bulk of the power module 1002 can be positioned below a surface 1005 of the cooling pool 1003. Accordingly, the cooling pool 1003 can operate as a thermal sink, for example, in the event of a system malfunction.

A volume between the reactor vessel 1020 and the containment vessel 1010 can be partially or completely evacuated to reduce heat transfer from the reactor vessel 1020 to the surrounding environment (e.g., to the cooling pool 1003). However, in other embodiments the volume between the reactor vessel 1020 and the containment vessel 1010 can be at least partially filled with a gas and/or a liquid that increases heat transfer between the reactor vessel 1020 and the containment vessel 1010. For example, the volume between the reactor vessel 1020 and the containment vessel 1010 can be at least partially filled (e.g., flooded with the primary coolant 1007) during an emergency operation.

Within the reactor vessel 1020, a primary coolant 1007 conveys heat from the reactor core 1004 to the steam generator 1030. For example, as illustrated by arrows located within the reactor vessel 1020, the primary coolant 1007 is heated at the reactor core 1004 toward the bottom of the reactor vessel 1020. The heated primary coolant 1007 (e.g., water with or without additives) rises from the reactor core 1004 through a core shroud 1006 and to a riser tube 1008. The hot, buoyant primary coolant 1007 continues to rise through the riser tube 1008, then exits the riser tube 1008 and passes downwardly through the steam generator 1030. The steam generator 1030 includes a multitude of conduits 1032 that are arranged circumferentially around the riser tube 1008, for example, in a helical pattern, as is shown schematically in FIG. 10. The descending primary coolant 1007 transfers heat to a secondary coolant (e.g., water) within the conduits 1032, and descends to the bottom of the reactor vessel 1020 where the cycle begins again. The cycle can be driven by the changes in the buoyancy of the primary coolant 1007, thus reducing or eliminating the need for pumps to move the primary coolant 1007.

The steam generator 1030 can include a feedwater header 1031 at which the incoming secondary coolant enters the steam generator conduits 1032. The secondary coolant rises through the conduits 1032, converts to vapor (e.g., steam), and is collected at a steam header 1033. The steam exits the steam header 1033 and is directed to the power conversion system 1040.

The power conversion system 1040 can include one or more steam valves 1042 that regulate the passage of high pressure, high temperature steam from the steam generator 1030 to a steam turbine 1043. The steam turbine 1043 converts the thermal energy of the steam to electricity via a generator 1044. The low-pressure steam exiting the turbine 1043 is condensed at a condenser 1045, and then directed (e.g., via a pump 1046) to one or more feedwater valves 241. The feedwater valves 1041 control the rate at which the feedwater re-enters the steam generator 1030 via the feedwater header 1031. In other embodiments, the steam from the steam generator 1030 can be routed for direct use in an industrial process, such as a Hydrogen (H₂) and Oxygen (O₂) production plant, a chemical production plant, and/or the like, as described in detail below. Accordingly, steam exiting the steam generator 1030 can bypass the power conversion system 1040.

The power module 1002 includes multiple control systems and associated sensors. For example, the power module 1002 can include a hollow cylindrical reflector 1009 that directs neutrons back into the reactor core 1004 to further the nuclear reaction taking place therein. Control rods 1013 are used to modulate the nuclear reaction. The control rods 1013 are coupled to control rod drive assemblies (CRDSAs) 1014. The CRDSAs 1014 are driven via control rod drive mechanisms (CRDMs) 1015. The pressure within the reactor vessel 1020 can be controlled via a pressurizer plate 1017 (which can also serve to direct the primary coolant 1007 downwardly through the steam generator 1030) by controlling the pressure in a pressurizing volume 1019 positioned above the pressurizer plate 1017.

The sensor system 1050 can include one or more sensors 1051 positioned at a variety of locations within the power module 1002 and/or elsewhere, for example, to identify operating parameter values and/or changes in parameter values. The data collected by the sensor system 1050 can then be used to control the operation of the system 1000, and/or to generate design changes for the system 1000. For sensors positioned within the containment vessel 1010, a sensor link 1052 directs data from the sensors to a flange 1053 (at which the sensor link 1052 exits the containment vessel 1010) and directs data to a sensor junction box 1054. From there, the sensor data can be routed to one or more controllers and/or other data systems via a data bus 1055.

FIG. 11 is a partially schematic, partially cross-sectional view of a nuclear reactor system 1100 configured in accordance with additional embodiments of the present technology. In some embodiments, the nuclear reactor system 1100 (“system 1100”) can include some features that are at least generally similar in structure and function, or identical in structure and function, to the corresponding features of the system 1100 described in detail above with reference to FIG. 11 and can operate in a generally similar or identical manner to the system 1100.

In the illustrated embodiment, the system 1100 includes a reactor vessel 1120 and a containment vessel 1110 surrounding/enclosing the reactor vessel 1120. In some embodiments, the reactor vessel 1120 and the containment vessel 1110 can be roughly cylinder-shaped or capsule-shaped. The system 1100 further includes a plurality of heat pipe layers 1111 within the reactor vessel 1120. In the illustrated embodiment, the heat pipe layers 1111 are spaced apart from and stacked over one another. In some embodiments, the heat pipe layers 1111 can be mounted/secured to a common frame 1112, a portion of the reactor vessel 1120 (e.g., a wall thereof), and/or other suitable structures within the reactor vessel 1120. In other embodiments, the heat pipe layers 1111 can be directly stacked on top of one another such that each of the heat pipe layers 1111 supports and/or is supported by one or more of the other ones of the heat pipe layers 1111.

In the illustrated embodiment, the system 1100 further includes a shield or reflector region 1114 at least partially surrounding a core region 1116. The heat pipe layers 1111 can be circular, rectilinear, polygonal, and/or can have other shapes, such that the core region 1116 has a corresponding three-dimensional shape (e.g., cylindrical, spherical). In some embodiments, the core region 1116 is separated from the reflector region 1114 by a core barrier 1115, such as a metal wall. The core region 1116 can include one or more fuel sources, such as fissile material, for heating the heat pipe layers 1111. The reflector region 1114 can include one or more materials configured to contain/reflect products generated by burning the fuel in the core region 1116 during operation of the system 1100. For example, the reflector region 1114 can include a liquid or solid material configured to reflect neutrons and/or other fission products radially inward toward the core region 1116. In some embodiments, the reflector region 1114 can entirely surround the core region 1116. In other embodiments, the reflector region 1114 may partially surround the core region 1116. In some embodiments, the core region 1116 can include a control material 1117, such as a moderator and/or coolant. The control material 1117 can at least partially surround the heat pipe layers 1111 in the core region 1116 and can transfer heat therebetween.

In the illustrated embodiment, the system 1100 further includes at least one heat exchanger 1130 (e.g., a steam generator) positioned around the heat pipe layers 1111. The heat pipe layers 1111 can extend from the core region 1116 and at least partially into the reflector region 1114 and are thermally coupled to the heat exchanger 1130. In some embodiments, the heat exchanger 1130 can be positioned outside of or partially within the reflector region 1114. The heat pipe layers 1111 provide a heat transfer path from the core region 1116 to the heat exchanger 1130. For example, the heat pipe layers 1111 can each include an array of heat pipes that provide a heat transfer path from the core region 1116 to the heat exchanger 1130. When the system 1100 operates, the fuel in the core region 1116 can heat and vaporize a fluid within the heat pipes in the heat pipe layers 1111, and the fluid can carry the heat to the heat exchanger 1130. The heat pipes in the heat pipe layers 1111 can then return the fluid toward the core region 1116 via wicking, gravity, and/or other means to be heated and vaporized once again.

In some embodiments, the heat exchanger 1130 can be similar to the steam generator 1030 of FIG. 10 and, for example, can include one or more helically-coiled tubes that wrap around the heat pipe layers 1111. The tubes of the heat exchanger 1130 can include or carry a working fluid (e.g., a coolant such as water or another fluid) that carries the heat from the heat pipe layers 1111 out of the reactor vessel 1120 and the containment vessel 1110 for use in generating electricity, steam, and/or the like. For example, in the illustrated embodiment the heat exchanger 1130 is operably coupled to a turbine 1143, a generator 1144, a condenser 1145, and a pump 1146. As the working fluid within the heat exchanger 1130 increases in temperature, the working fluid may begin to boil and vaporize. The vaporized working fluid (e.g., steam) may be used to drive the turbine 1143 to convert the thermal potential energy of the working fluid into electrical energy via the generator 1144. The condenser 1145 can condense the working fluid after it passes through the turbine 1143, and the pump 1146 can direct the working fluid back to the heat exchanger 1130 where it can begin another thermal cycle. In other embodiments, steam from the heat exchanger 1130 can be routed for direct use in an industrial process, such as an enhanced oil recovery operation described in detail below. Accordingly, steam exiting the heat exchanger 1130 can bypass the turbine 1143, the generator 1144, the condenser 1145, the pump 1146, etc.

FIG. 12 is a schematic view of a nuclear power plant system 1250 including multiple nuclear reactors 1200 in accordance with embodiments of the present technology. Each of the nuclear reactors 1200 (individually identified as first through twelfth nuclear reactors 1200a-1, respectively) can be similar to or identical to the nuclear reactor 1200 and/or the nuclear reactor 1200 described in detail above with reference to FIGS. 10 and 11. The power plant system 1250 (“power plant system 1250”) can be “modular” in that each of the nuclear reactors 1200 can be operated separately to provide an output, such as electricity or steam. The power plant system 1250 can include fewer than twelve of the nuclear reactors 1200 (e.g., two, three, four, five, six, seven, eight, nine, ten, or eleven of the nuclear reactors 1200), or more than twelve of the nuclear reactors 1200. The power plant system 1250 can be a permanent installation or can be mobile (e.g., mounted on a truck, tractor, mobile platform, and/or the like). In the illustrated embodiment, each of the nuclear reactors 1200 can be positioned within a common housing 1251, such as a reactor plant building, and controlled and/or monitored via a control room 1252.

Each of the nuclear reactors 1200 can be coupled to a corresponding electrical power conversion system 1240 (individually identified as first through twelfth electrical power conversion systems 1240a-1, respectively). The electrical power conversion systems 1240 can include one or more devices that generate electrical power or some other form of usable power from steam generated by the nuclear reactors 1200. In some embodiments, multiple ones of the nuclear reactors 1200 can be coupled to the same one of the electrical power conversion systems 1240 and/or one or more of the nuclear reactors 1200 can be coupled to multiple ones of the electrical power conversion systems 1240 such that there is not a one-to-one correspondence between the nuclear reactors 1200 and the electrical power conversion systems 1240.

The electrical power conversion systems 1240 can be further coupled to an electrical power transmission system 1254 via, for example, an electrical power bus 1253. The electrical power transmission system 1254 and/or the electrical power bus 1253 can include one or more transmission lines, transformers, and/or the like for regulating the current, voltage, and/or other characteristic(s) of the electricity generated by the electrical power conversion systems 1240. The electrical power transmission system 454 can route electricity via a plurality of electrical output paths 1255 (individually identified as electrical output paths 1255a-n) to one or more end users and/or end uses, such as different electrical loads of an integrated energy system.

Each of the nuclear reactors 1200 can further be coupled to a steam transmission system 1256 via, for example, a steam bus 1257. The steam bus 1257 can route steam generated from the nuclear reactors 1200 to the steam transmission system 1256 which in turn can route the steam via a plurality of steam output paths 1258 (individually identified as steam output paths 1258a-n) to one or more end users and/or end uses, such as different steam inputs of an integrated energy system.

In some embodiments, the nuclear reactors 1200 can be individually controlled (e.g., via the control room 1252) to provide steam to the steam transmission system 1256 and/or steam to the corresponding one of the electrical power conversion systems 1240 to provide electricity to the electrical power transmission system 1254. In some embodiments, the nuclear reactors 1200 are configured to provide steam either to the steam bus 1257 or to the corresponding one of the electrical power conversion systems 1240 and can be rapidly and efficiently switched between providing steam to either. Accordingly, in some aspects of the present technology the nuclear reactors 1200 can be modularly and flexibly controlled such that the power plant system 1250 can provide differing levels/amounts of electricity via the electrical power transmission system 1254 and/or steam via the steam transmission system 1256. For example, where the power plant system 1250 is used to provide electricity and steam to one or more industrial process-such as various components of the integrated energy systems, the nuclear reactors 1200 can be controlled to meet the differing electricity and steam requirements of the industrial processes.

As one example, during a first operational state of an integrated energy system employing the power plant system 1250, a first subset of the nuclear reactors 1200 (e.g., the first through sixth nuclear reactors 1200a-f) can be configured to provide steam to the steam transmission system 1256 for use in the first operational state of the integrated energy system, while a second subset of the nuclear reactors 1200 (e.g., the seventh through twelfth nuclear reactors 1200g-1) can be configured to provide steam to the corresponding ones of the electrical power conversion systems 1240 (e.g., the seventh through twelfth electrical power conversion systems 1240g-1) to generate electricity for the first operational state of the integrated energy system. Then, during a second operational state of the integrated energy system when a different (e.g., greater or lesser) amount of steam and/or electricity is required, some or all the first subset of the nuclear reactors 1200 can be switched to provide steam to the corresponding ones of the electrical power conversion systems 1240 (e.g., the seventh through twelfth electrical power conversion systems 1240g-1) and/or some or all of the second subset of the nuclear reactors 1200 can be switched to provide steam to the steam transmission system 1256 to vary the amount of steam and electricity produced to match the requirements/demands of the second operational state. Other variations of steam and electricity generation are possible based on the needs of the integrated energy system. That is, the nuclear reactors 1200 can be dynamically/flexibly controlled during other operational states of an integrated energy system to meet the steam and electricity requirements of the operational state.

In contrast, some conventional nuclear power plant systems can typically generate either steam or electricity for output and cannot be modularly controlled to provide varying levels of steam and electricity for output. Moreover, it is typically difficult (e.g., expensive, time consuming, etc.) to switch between steam generation and electricity generation in conventional nuclear power plant systems. Specifically, for example, it is typically extremely time consuming to switch between steam generation and electricity generation in prototypical large nuclear power plant systems.

The nuclear reactors 1200 can be individually controlled via one or more operators and/or via a computer system. Accordingly, many embodiments of the technology described herein may take the form of computer- or machine- or controller-executable instructions, including routines executed by a programmable computer or controller. Those skilled in the relevant art will appreciate that the technology can be practiced on computer/controller systems other than those shown and described herein. The technology can be embodied in a special-purpose computer, controller or data processor that is specifically programmed, configured, or constructed to perform one or more of the computer-executable instructions described below. Accordingly, the terms “computer” and “controller” as generally used herein refer to any data processor and can include Internet appliances and hand-held devices (including palm-top computers, wearable computers, cellular or mobile phones, multi-processor systems, processor-based or programmable consumer electronics, network computers, mini computers and the like). Information handled by these computers can be presented at any suitable display medium, including a liquid crystal display (LCD).

The technology can also be practiced in distributed environments, where tasks or modules are performed by remote processing devices that are linked through a communications network. In a distributed computing environment, program modules or subroutines may be located in local and remote memory storage devices. Aspects of the technology described herein may be stored or distributed on computer-readable media, including magnetic or optically readable or removable computer disks, as well as distributed electronically over networks. Data structures and transmissions of data particular to aspects of the technology are also encompassed within the scope of the embodiments of the technology.

### CONCLUSION

Although several embodiments have been described in language specific to structural features and/or methodological acts, it is to be understood that the claims are not necessarily limited to the specific features or acts described. Rather, the specific features and acts are disclosed as illustrative forms of implementing the claimed subject matter.

What is claimed is:

1. An integrated system for latching a shaft assembly, the integrated system comprising:
a nuclear power reactor configured to raise a stem of the shaft assembly into a hold out;
the hold out, including:
a sleeve, and metallic balls, the metallic balls being positioned in openings of the sleeve,
a housing positioned around the sleeve and the metallic balls, the housing including a gap that is narrower than a chamber of the housing, and
a spring; and
an electromagnetic coil configured to engage the spring and the plunger to raise a stem until the metallic balls are moved from positions between a gap of the housing and the stem, to positions between a chamber of the housing and the stem.

2. The integrated system for latching the shaft assembly of claim 1, wherein the electromagnetic coil is configured to raise the spring and the sleeve until the metallic balls are moved from the positions between the gap of the housing and a channel of the stem, to the positions between the chamber of the housing and the channel of the stem during dis-engagement.

3. The integrated system for latching a shaft assembly of claim 1, wherein:
the metallic balls and the openings are disposed around a bottom portion of the sleeve;
the housing includes a sidewall configured to maintain contact with the sleeve; and
the spring is coupled to the sleeve and configured to apply a force on the sleeve to hold the sleeve during a dis-engagement of the shaft assembly.

4. The integrated system for latching a shaft assembly of claim 1, wherein the housing includes a gap having a first diameter and a chamber above the gap, the chamber having a second diameter that is larger than the first diameter.

5. The integrated system for latching a shaft assembly of claim 1, wherein the metallic balls are disposed around a bottom portion of a sleeve within the hold out, and the sleeve is configured to planarly engage with a sidewall of the housing.

6. The integrated system for latching a shaft assembly of claim 1, wherein a top portion of the stem is configured to engage with the sleeve within the hold out.

7. The integrated system for latching a shaft assembly of claim 1, wherein the electromagnetic coil is configured to, when energized, generate an electromagnetic force to control the spring to hold the sleeve within the hold out, during dis-engagement of the shaft assembly.

8. The integrated system for latching a shaft assembly of claim 1, wherein the metallic balls are configured to freely move laterally with the openings.

9. The integrated system for latching a shaft assembly of claim 1, wherein the shaft assembly includes a channel defined by an upper lip and a lower lip separated by a distance sufficient for the metallic balls to be partially disposed within the channel.

10. The integrated system for latching a shaft assembly of claim 1, wherein the shaft assembly includes a channel defined by an upper lip and a lower lip, the channel being configured to enable movement of the metallic balls.

11. The integrated system for latching a shaft assembly of claim 1, wherein the shaft assembly includes a lower portion that is couplable to a control rod.

12. A latching system, comprising:
an electromagnetic coil;
a hold out associated with the electromagnetic coil, the hold out including a sleeve having metallic balls disposed around a bottom portion of the sleeve;
a shaft assembly in a nuclear power module configured to engage with the hold out; and
a drive coil positioned within the nuclear power module, the drive coil configured to move the shaft assembly.

13. The latching system of claim 12, wherein the hold out includes:
a housing;
a sleeve disposed within the housing, the sleeve configured to move vertically within the housing; and
a spring coupled to a top portion of the sleeve, the spring configured to apply a force on the top portion of the plunger.

14. The latching system of claim 12, wherein the hold out includes a housing having a gap with a first diameter and a chamber above the gap, the chamber having a second diameter that is larger than the first diameter.

15. The latching system of claim 12, wherein the electromagnetic coil is configured to, when energized, generate an electromagnetic force to compress a spring associated with the hold out.

16. The latching system of claim 12, wherein the metallic balls are configured to freely move laterally with openings disposed around the bottom portion of the sleeve.

17. The latching system of claim 12, wherein the shaft assembly includes a channel defined by an upper lip and a lower lip, the channel being configured to enable movement of the metallic balls.

18. A method for controlling a shaft assembly, the method comprising:
moving, via a drive coil, an upper portion of the shaft assembly into a hold out;
raising, via the upper portion of the shaft assembly, a sleeve within the hold out to reposition metallic balls disposed around a bottom portion of the sleeve; and
lowering, via the drive coil, the upper portion of the shaft assembly to rest on the metallic balls within the hold out.

19. The method of claim 18, wherein the hold out includes a sleeve having metallic balls disposed along a lower portion of the sleeve and the upper portion of the shaft assembly includes a channel configured to partially envelop the metallic balls.

20. The method of claim 18, wherein the sleeve is raised within a housing, the housing having:
a bottom portion having a first diameter, and
an upper portion having a second diameter that is greater than the first diameter.
